(19) United States
(12) Patent Application Publication
(10) Pub. No.: US 2012/0229833 A1
(43) Pub. Date: Sep. 13, 2012

(54) PRINTING SYSTEM, INFORMATION PROCESSING APPARATUS, CONTROL METHOD, AND COMPUTER-READABLE MEDIUM

(75) Inventor: Masashi Nakagawa, Sagamihara-shi (JP)

(73) Assignee: CANON KABUSHIKI KAISHA, Tokyo (JP)

(21) Appl. No.: 13/397,349

(22) Filed: Feb. 15, 2012

(30) Foreign Application Priority Data
Mar. 7, 2011 (JP) 2011-049608

(51) Int. Cl. G06K 15/02

(52) U.S. Cl. 358/1.13

(57) ABSTRACT

An information processing apparatus which includes a printer driver for generating a print job of an intermediate data format independent of a printing apparatus of a specific model, comprises: a unit configured to register sheet information set in advance by a user as a user registration sheet; a unit configured to acquire sheet information from setting information of the print job; a unit configured, when the user registration sheet is designated in the acquired sheet information, to acquire information of the registered, user registration sheet, and to set the information of the user registration sheet in the setting information of the print job; and a unit configured to transmit, to a print server, the print job including the setting information in which the setting unit sets the information of the user registration sheet.

### BACKGROUND OF THE INVENTION

1. Field of the Invention

The present invention relates to a pull print control method and, more particularly, to a printing system, information processing apparatus, control method, and computer-readable medium.

2. Description of the Related Art

There has conventionally been proposed a so-called “pull print” printing system capable of outputting print data from a printing apparatus when the user issues, from the printing apparatus, a print request for print data temporarily stored in a server (see, for example, Japanese Patent No. 4033857). The user can output print data not from a specific printing apparatus designated by an application in printing, but from a printing apparatus of his choice.

Generally in the client/server environment of the same platform, a printer driver running on the client can refer to the sheet information database of the server for sheet information used in printing. In the client/server environment of a different platform, the printer driver running on the client adds sheet information and transfers it to the server when generating a spool file. On the server side, upon receiving the sheet information, a spool cooperation unit refers to the sheet information added to the spool file and reflects it in print data. This mechanism has also been proposed (see, for example, Japanese Patent NO. 4119868).

It is difficult for the conventional method to designate a change of print settings when the user issues, from the printing apparatus, a print request for print data temporarily stored in the server. This is because print data temporarily stored in the server has a PDL (Page Description Language) format dependent on a printing apparatus and PPL needs to be edited according to a print setting change instruction.

For example, assume that the user designates a print setting to impose four pages on one page (to be referred, to as 4in1) when he issues, from the printing apparatus, a print request for print data temporarily stored in the server. At this time, print data temporarily stored in the server, that is, PDL needs to be changed to match 4in1. If PDL is a raster format dependent on the resolution of the printing apparatus, a raster image is reduced to implement 4in1, causing various quality problems such as loss of a thin line. Since PDL has a variety of specifications, much labor is required to cope with these PDL specifications. In the first place, if a PDL specification is not open to the public, no PDL content can be changed. If no PDL content can be changed, a model to print is limited when the user issues a print instruction, and the model cannot be freely changed in pull print.

To solve these problems, a printing system capable of editing data again on the server side is needed. However, a match with sheet information managed by the client is not always established.

### SUMMARY OF THE INVENTION

The present invention has been made to solve the above problems, and provides a printing system capable of pull print with an appropriate sheet setting the user wants.

According to one aspect of the present, invention, there is provided an information processing apparatus which is connected to a print server and includes a printer driver for generating a print job of an intermediate data format independent of a printing apparatus of a specific model, comprising; a registration unit configured to register, in a storage unit, sheet information set in advance by a user as a user registration sheet; a first acquisition unit configured to acquire sheet information from print setting information of the print job; a setting unit configured, when the user registration sheet is designated in the sheet information acquired by the first acquisition unit, to acquire information of the user registration sheet from the storage unit, and to set the information of the user registration sheet in the print setting information of the print job; and a transmission unit configured to transmit, to the print server, the print job including the print setting information, in which the setting unit sets the information of the user registration sheet.

According to another aspect of the present invention, there is provided a printing system comprising a client apparatus including a printer driver for generating a print job of an intermediate data format independent of a printing apparatus of a. specific model, a print server, and a printing apparatus, the client apparatus including: a registration unit configured to register, in a storage unit, sheet information set in advance by a user as a user registration sheet; a first acquisition unit configured to acquire sheet information from print setting information of the print job; a setting unit configured, when the user registration sheet is designated in the sheet information acquired by the first acquisition unit, to acquire information of the user registration sheet from the storage unit, and to set the information of the user registration sheet in the print setting information of the print job; and a transmission unit configured to transmit, to the print server, the print job including the print setting information in which the setting unit sets the information of the user registration sheet, the print server including: a holding unit configured to hold, in a storage unit, the print job received from the client apparatus; and a conversion unit configured, in response to a received print request, to convert the print job of the intermediate data format held in the storage unit into a data format corresponding to the printing apparatus using the print setting information, and to transmit the print job to the printing apparatus, and the printing apparatus including; an instruction unit configured to transmit the print request to the print server; and a printing unit configured to receive the print job transmitted from the print server, and to print in response to the print request from the instruction unit.

According to another aspect of the present invention, there is provided a method of controlling an information processing apparatus which is connected to a print server and includes a printer driver for generating a print job of an intermediate data format independent of a printing apparatus of a specific model, comprising: a registration step of registering, in a storage unit, sheet information set in advance by a user as a user registration sheet; an acquisition step of acquiring sheet information from print setting information of the print job; a setting step of, when the user registration sheet is designated in the sheet information acquired in the acquisition step, acquiring information of the user registration sheet from the storage unit, and setting the information of the user registration sheet in the print setting information of the print job; and a transmission step of transmitting, to the print server, the print job including the print setting information in which the information of the user registration sheet is set in the setting step.

According to another aspect of the present invention, there is provided a control method in a printing system including a client apparatus including a printer driver for generating a print job of an intermediate data format independent of a printing apparatus of a specific model, a print server, and a printing apparatus, comprising: in the client apparatus, a registration step of registering, in a storage unit, sheet information set in advance by a user as a user registration sheet; a first acquisition step of acquiring sheet information from print setting information of the print job; a setting step of, when the user registration sheet is designated in the sheet information acquired in the first acquisition step, acquiring information of the user registration sheet from the storage unit, and setting the information of the user registration sheet in the print setting information of the print job; and a transmission step of transmitting, to the print server, the print job including the print setting information in which the information of the user registration sheet is set in the setting step, in the print server, a holding step of holding, in a storage unit, the print job received from the client apparatus; and a conversion step of, in response to a received print request, converting the print job of the intermediate data format held in the storage unit into a data format corresponding to the printing apparatus using the print setting information, and transmitting the print job to the printing apparatus, and in the printing apparatus, an instruction step of transmitting the print request to the print server; and a printing step of receiving the print job transmitted from the print server, and performing printing in response to the print request from the instruction step.

According to another aspect of the present invention, there is provided a non-transitory computer-readable medium storing a program for causing a computer to function as a registration unit configured to register, in a storage unit, sheet information set in advance by a user as a user registration sheet, an acquisition unit configured to acquire sheet information from print setting information of the print job, a setting unit configured, when the user registration sheet is designated in the sheet information acquired, by the acquisition unit, to acquire information of the user registration sheet from the storage unit, and to set the information of the user registration, sheet in the print setting information, of the print job, and a transmission unit configured to transmit, to the print server, the print job including the print setting information in which the setting unit sets the information of the user registration sheet.

According to the present invention, when the user issues, from a printing apparatus, a print request for print data temporarily stored in a server, he can designate a change of print settings. Further, printing can be performed with a sheet, setting the user wants, without causing a mismatch in a print setting in a client PC.

Further features of the present invention will become apparent from the following description of exemplary embodiments (with reference to the attached drawings).

### BRIEF DESCRIPTION OF THE DRAWINGS

FIG. 1 is a view exemplifying the arrangement of a printing system;

FIG. 2 is a block diagram showing the hardware arrangement of each apparatus;

FIG. 3 is a block diagram exemplifying the hardware arrangement of the controller unit of a multi-function peripheral;

FIG. 4 is a schematic view for explaining an overall pull print sequence in the printing system;

FIGS. 5A and 5E are tables showing details of each data sequence shown in FIG. 4;

FIG. 6 is a schematic view exemplifying the printing screen of an application program running on a client PC;

FIGS. 7A and 7B are flowcharts exemplifying the first control processing sequence in the printing system;

FIGS. 8A and 8B are flowcharts exemplifying the second control processing sequence in the printing system;

FIGS. 9A and 9B are flowcharts exemplifying the third control processing sequence in the printing system;

FIG. 10 is a flowchart showing a logical printer generation sequence in the printing system;

FIG. 11 is a flowchart exemplifying the fourth control processing sequence in the printing system;

FIG. 12 is a flowchart exemplifying the fifth control processing sequence in the printing system;

FIG. 13 is a view showing details of data flowing between steps SB703 and SC701 in FIGS. 7A and 7B;

FIGS. 14A and 14B are views showing details of data flowing between steps SC809 and SE811 in FIGS. 8A and 8B;

FIGS. 15A and 15E are views each showing details of the structure of data flowing in processing of FIGS. 9A and 9B;

FIGS. 16A, 16B, and 16C are schematic views each showing a screen displayed on the display unit of the multi-function peripheral under the control of the CPU;

FIGS. 17A, 17B, and 17C are schematic views each exemplifying a screen displayed on the display unit of the multi-function peripheral under the control of the CPU;

FIG. 18 is a view exemplifying a sheet setting mismatch generated in a pull print system;

FIG. 19 is a flowchart exemplifying sheet size information update processing;

FIG. 20 is a flowchart exemplifying sheet size information update processing; and

FIG. 21 is a schematic view exemplifying a screen which notifies whether to replace sheet size information.

### DESCRIPTION OF THE EMBODIMENTS

Embodiments of the present invention will now be described with reference to the accompanying drawings.

### First Embodiment

[System Arrangement]

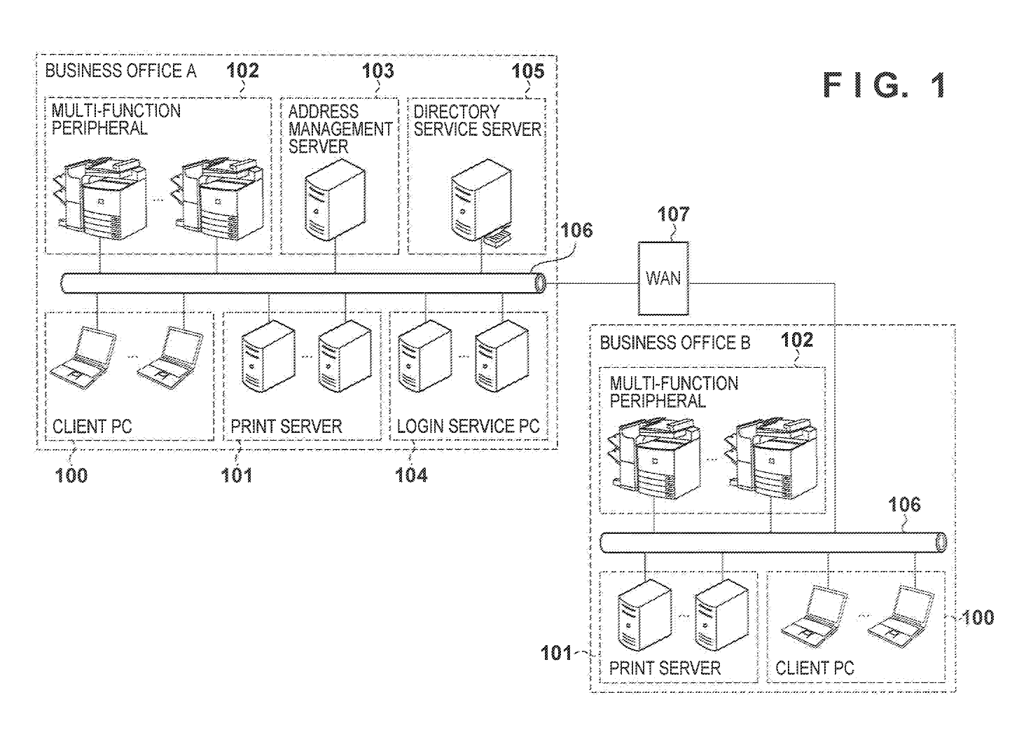

FIG. 1 is a view exemplifying the arrangement of a printing system to which a client PC, print server, address management server, and printing apparatus according to the embodiment are applicable. Like “business office A” in FIG. 1, the printing system in the embodiment includes one or more client PCs 100 (for example, for respective users), one or mere print servers 101 (for example, installed on respective floors), and one or more multi-function peripherals 102 (for example, installed, on respective floors). Further, the printing system is configured by connecting an address management server 103, one or more login service PCs 104 (for example, installed on respective floors), and a directory service server 105 via a local area network (LAN) 106.

A virtual printer driver and print processor are installed in the client PC 100 serving as a client apparatus. The virtual printer driver generates a print job of an intermediate data format independent of a specific multi-function peripheral model based on data received from a client application, and transmits it to the print server 101 via the print processor. Note that a print job of an intermediate data format indicates print data of a format which has format specifications open to the public and facilitates reediting. Examples are EMFSPOOL (Enhanced Metafile Spool Format) and XPS (XML Paper Specification). The embodiment will adopt the EMFSPOOL format, but print data of another intermediate data format such as XPS or PDF is also available.

The print server 101 stores the received, print job in a predetermined storage location serving as a storage unit. The print server 101 includes a job management database (to be referred to as job management DB), and stores and manages metadata regarding the print job in the job management DB. The print server 101 generates print job list data from the metadata recorded and managed in the job management DB, and transfers it to the multi-function peripheral 102. The print server 101 updates print setting information using the metadata recorded and managed in the job management DB and print setting information received from the multi-function peripheral 102. The print server 101 transfers the updated print settings to the multi-function peripheral 102. The print server 101 generates PDL (Page Description Language) data from the print, job saved in the predetermined storage location and the metadata which is recorded and managed in the job management DB. The print server 101 transfers the generated PDL data to the multi-function peripheral 102.

The address management server 103 includes an address management database (to be referred to as address management DB). When executing “pull print” in the embodiment, the address management server 103 manages, in the address management DB, the address and user identifier of the print server 101 which manages a print job. As a response to a print job list request from the multi-function peripheral 102, the address management server 103 transmits, to the multi-function peripheral 102, the address of a print server 101 corresponding to a user identifier received from the multi-function peripheral 102.

The login service PC 104 provides a login service for the multi-function peripheral 102. As its function, the login service PC 104 performs authentication processing (to be referred to as SSO:Single Sign-On) based, on the login user name and password of the client PC 100 that are stored and managed in the directory service server 105. The login user name and password are, for example, a login user name and password used in Microsoft Windows®. An example of the login service PC is a personal computer in which Security Agent available from CANON is installed.

The directory service server 105 unitarily stores and manages information about hardware resources such as a server, client, and printer on a network, and the attributes, access rights, and the like of users of these hardware resources. The user attributes include the login user name and password of the client PC 100 (for example, a login user name and password in Microsoft Windows®). An example of the directory service server is a server having an active directory function.

The printing system of the embodiment may be configured by connecting, via a WAN 107, “business office A” having the above arrangement and “business office B” having one or more arrangements identical to that of “business office A”.

Note that the above-described arrangement is merely an example, and the arrangement may further include another apparatus or may be connected by a wireless network (for example, wireless LAN). Also, a larger number of “business offices” may be connected.

[Hardware Arrangement]

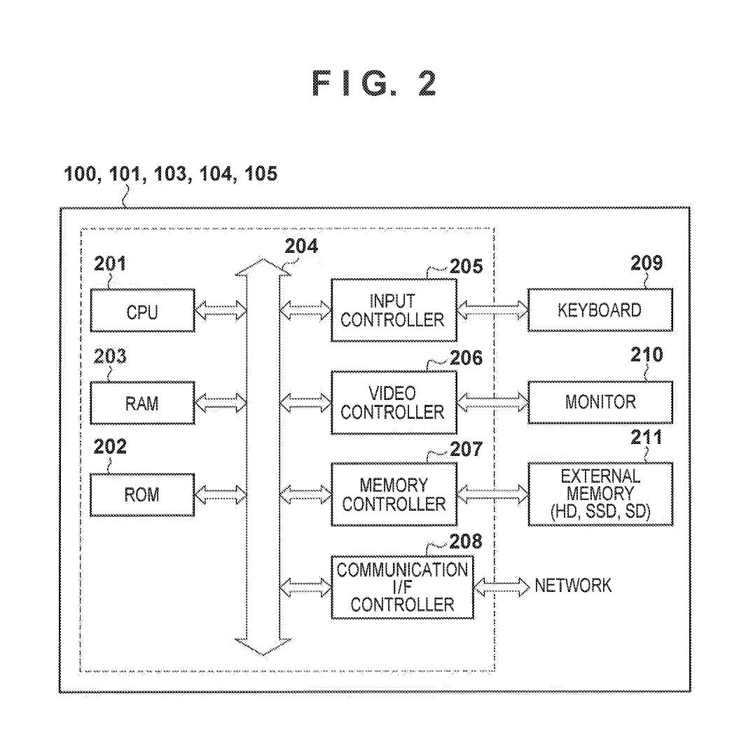

The hardware arrangement of an information processing apparatus applicable to the client PC 100, print server 101, address management server 103, login service PC 104, and directory service server 105 shown in FIG. 1 will be exemplified with reference to FIG. 2.

Referring to FIG. 2, a CPU 201 comprehensively controls respective devices and controllers connected to a system bus 204. A ROM 202 or external memory 211 stores a BIOS (Basic Input/Output System) and operating system (to be referred to as OS) serving as control programs of the CPU 201. The ROM 202 or external memory 211 also stores various programs (to be described later) necessary to implement functions to be executed by each server or each PC. A RAM 203 functions as a main memory, work area, and the like for the CPU 201. The CPU 201 loads, from the ROM 202 or external memory 211 into the RAM 203, programs and the like necessary to execute processing, and executes the loaded programs to implement various operations. An input controller 205 controls inputs from a keyboard 209, a pointing device such as a mouse (not shown), and the like. A video controller 206 controls display on a monitor 210. In general, the monitor 210 is a display device such as a liquid crystal display or CRT. The administrator uses these devices, as needed.

A memory controller 207 controls access to the external memory 211. The external memory 211 is a hard disk (HD), SSD (Solid State Drive), SD memory card, or the like which stores a boot program, various applications, font data, user files, edit files, various data, and the like. A communication I/F controller 208 connects/communicates with an external device via a network (for example, the LAN 106 shown in FIG. 1), and executes network communication control processing. For example, communication using TCP/TP is possible in this printing system. Note that the CPU 201 enables display on the monitor 210 by executing, for example, outline font rasterisation processing to a display information area in the RAM 203. The CPU 201 enables a user instruction with a mouse cursor (not shown) on the monitor 210. Various programs (to be described later) for implementing the embodiment are recorded in the external memory 211, and if necessary, loaded into the RAM 203 and executed, by the CPU 201. The external memory 211 stores even definition tiles, various information tables, and the like used to execute the programs, which will, also be described in detail later.

Note that the hardware arrangement of each apparatus shown in FIG. 2 is that of a general information processing apparatus, and each apparatus may adopt another arrangement.

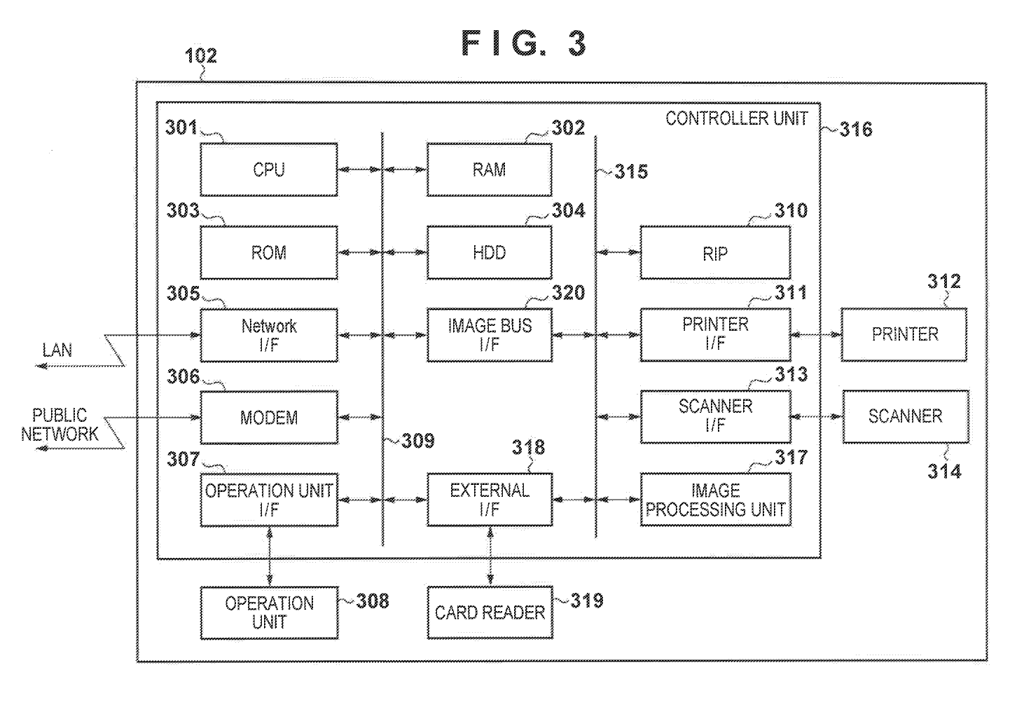

The hardware arrangement, of a controller unit 316 which controls the multi-function peripheral 102 shown in FIG. 1 will be exemplified with reference to FIG. 3. Referring to FIG. 3, the controller unit 316 is connected to a scanner 314 functioning as an image input device and a printer 312 functioning as an image output device. In addition, the controller unit 316 is connected to a LAN (for example, the LAN 106 shown in FIG. 1) and a public line (WAN) (for example, PSTN or ISBN) to input/output image data and device information. In the controller unit 316, a CPU 301 is a processor which controls the overall system.

A RAM 302 is a system work memory necessary for the CPU 301 to run, and is also a program memory for storing programs and an image memory for temporarily storing image data. A ROM 303 stores a boot program and various control programs for the system. A hard, disk drive (HDD) 304 stores various programs for controlling the system, image data, and the like. An operation unit interface (I/F) 307 is an interface with an operation unit (UI) 308, and outputs, to the operation unit 308, image data to be displayed, on the operation unit 308. Also, the operation unit I/F 307 notifies the CPU 301 of information (for example, user information) input by the user of the system via the operation unit 308. Note that the operation unit 308 includes a display unit (not shown) having a touch panel. The user presses (touches with his finger or the like) buttons displayed on the display unit to input various instructions.

A network interface (I/F) 305 is connected to a network (LAN) to input/output data. A modem 306 is connected to a public line to perform data input/output such as FAX transmission/reception. An external interface (I/F) 318 is an I/F unit for accepting an external input via a USB, IEEE1394, printer port, RS-232C, or the like. In the embodiment, a card reader 319 is connected to the external I/F 318 to read an IC card, necessary for authentication. The CPU 301 controls reading of information from the IC card by the card reader 319 via the external I/F 318, and the controller unit 316 can acquire the information read from the IC card. These devices are arranged on a system bus 309.

An image bus interface (I/F) 320 is a bus bridge which, connects the system bus 309 and an image bus 315 for transferring image data at high speed, and converts the data structure. The image bus 315 is formed, from, a PCI bus or IEEE1394 bus. The following devices are arranged on the image bus 315. A raster image processor (RIP) 310 rasterizes vector data such as a PDL code into a bitmap image. A printer interface (I/F) 311 connects the printer 312 and controller unit 316, and performs synchronous/asynchronous conversion of image data. A scanner interface (I/F) 313 connects the scanner 314 and controller unit 316, and performs synchronous/asynchronous conversion of image data. An image processing unit 317 performs correction, processing, and editing for input image data, and performs printer correction, resolution conversion, and the like for printout image data. In addition, the image processing unit 317 rotates image data, and compresses/decompresses multi-valued image data by JPEG or binary image data by JBIG, MMR, MH, or the like.

The scanner 314 illuminates an image on a document sheet, and scans it with a CCD line sensor to convert it into an electrical signal as raster image data. The user sets document sheets in the tray of a document feeder, and designates the start of reading from the operation unit 308. Then, the CPU 301 gives an instruction to the scanner 314. The document feeder feeds the document sheets one by one to read document images. The printer 312 converts raster image data into an image on a sheet. The printer 312 employs, for example, an electrophotographic method using a photosensitive drum or photosensitive belt, or an inkjet method of discharging ink from a small nozzle array to directly print an image on a sheet, but the method is arbitrary. The print operation starts in response to an instruction from the CPU 301. Note that the printer 312 includes a plurality of sheet feed stages and corresponding sheet cassettes so that different sheet sizes or different sheet orientations can be selected.

The operation unit 308 includes an LCD display unit, and a touch panel sheet is adhered onto the LCD. The operation unit 308 displays a system, operation screen, and when the user presses a displayed key, notifies the CPU 3G1 via the operation unit I/F 307 of the position information. The operation unit 308 includes various operation keys such sis a start key, stop key, ID key, and reset key. The start key of the operation unit 308 is used to, for example, start a document image reading operation. A two-color (green and red) LED is arranged at the center of the start key, and the color represents whether the start key is usable. The stop key of the operation unit 308 is used to stop a running operation. The ID key of the operation unit 308 is used to input the user ID. The reset key is used to initialise settings from the operation unit.

The card reader 319 reads information stored in an IC card (for example, FeliCa® available from Sony) under the control of the CPU 301, and notifies the CPU 301 via the external I/F 818 of the read information. With this arrangement, the multi-function peripheral 102 can transmit image data scanned by the scanner 314 to the LAN 106, and use the printer 312 to print out print data received from the LAN 106. Also, the multi-function peripheral 102 can FAX-send image data scanned by the scanner 314 to the public line via the modem 306, and use the printer 312 to output image data FAX-received from the public line.

[Pull Print Sequence]

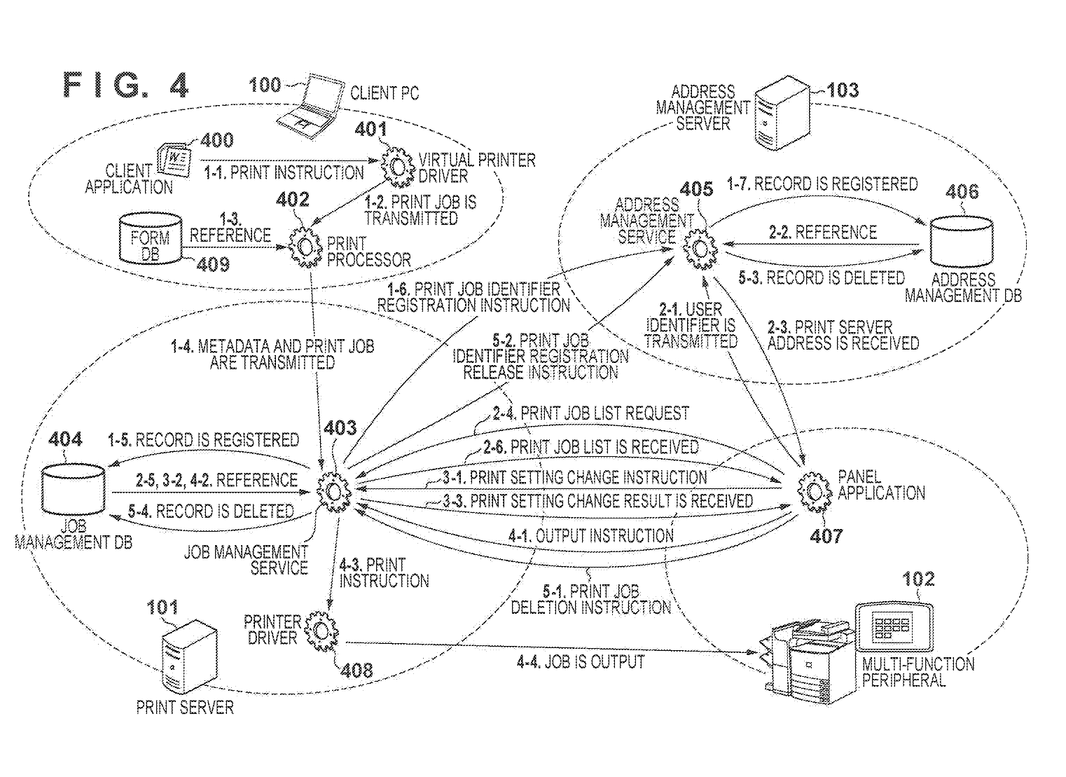

An overall pull print sequence in the printing system according to the embodiment will be explained with reference to FIG. 4. Before this, preconditions to execute pull print in the embodiment will be explained. A virtual printer driver 401 is installed as a shared printer in the client PC 100 to implementing pull print in the embodiment. The virtual printer driver 401 generates print data based on designated printing or output of a rendering instruction from an application. Further, the virtual printer driver 401 has a function (user interface) of making print settings for controlling the functions of the virtual printer driver 401 and printer, and a function of storing the print settings in an external storage device for each installed logical printer. The print settings are stored in a DEVMODE structure for Windows® available from Microsoft, USA.

The DEVMODE structure is defined by Microsoft, USA to store various settings including default operation conditions regarding a logical printer, such as functions usable by a printer, layout setting, finishing setting, sheet feed/discharge setting, and print quality setting. These set values are stored in the external storage device for each installed, logical printer. A logical printer corresponding to the virtual printer driver 401 and a print processor 402 corresponding to the virtual printer driver 401 are added to the client PC 100.

The overall pull print sequence according to the embodiment will be described. FIG. 4 is a schematic view tor explaining an overall pull print sequence in the printing system according to the embodiment. As shown in FIG. 4, the user first logs in to the client PC 100, and inputs a print instruction from a client application 400 executed in the client PC 100 to a logical printer corresponding to the virtual printer driver 401 (1-1). In response to the print instruction, the client application 400 of the client PC 100 transmits data to the virtual printer driver 401 via a graphic engine. The virtual printer driver 101 of the client PC 100 generates a device (printer device)—independent EMFSPOOL print job based on the data received from the client application 400 via the graphic engine. The virtual printer driver 401 transmits the generated EMFSPOOL print job to the print processor 402 (1-2).

The print processor 402 reads the EMFSPOOL print job transmitted from the virtual printer driver 401, and generates metadata of the print job. The print, processor 402 transmits the generated metadata and print job to the job management service of the print server 101 (1-4).

In the print server 101, a job management service 403 saves the received EMFSPOOL print job in a predetermined storage location in the print server 101, and registers the metadata in a job management DE 404 (1-5). The job management DB 404 is built in the external storage device of the print server 101. At this time, the print server 101 only saves the print job in the predetermined storage location without transmitting it to the printing apparatus (for example, the multi-function peripheral 102). Further, the print server 101 transmits a print job identifier and user identifier to register them in an address management service 405 in the address management server 103, and issues a registration instruction (1-6).

Upon, receiving the print job identifier and user identifier from the job management service 403 of the print server 101, the address management service 405 registers them in an address management DB 406 in addition to the address of the print server 101 serving as the transmission source (1-7). The address management DB 406 is built in the external storage device of the address management server 103. Note that the embodiment uses an IP address as an address for discriminating a device. The embodiment uses a GUID (Global Unique Identifier) as the job identifier. However, the job identifier is not limited to this scheme, and may employ another scheme as long as information is identifiable. As for each DB, the building location is not limited.

When the card reader 319 in the multi-function peripheral 102 detects a readable IC card, it reads individual authentication information in the IC card. The multi-function peripheral 102 transmits the individual authentication information read by the card reader 319 as an authentication request to an authentication server (not shown). The individual authentication information is information used for authentication and may be the serial number of the IC card or the like. Upon receiving the individual authentication information from the multi-function peripheral 102, the authentication server performs authentication processing for the individual authentication information based on an IC card authentication table stored in the external storage device of the authentication server. As a response to the request, the authentication server sends back the authentication result to the multi-function peripheral 102. The embodiment assumes that the authentication server transmits the user identifier of the client PC 100 as the authentication result if the authentication processing is successful. Note that the address management server 103 may have the authentication server function.

A panel application 407 in the multi-function peripheral 102 receives, from the authentication server, the authentication result (login user identifier of the client PC 100) indicating that authentication is successful. The embodiment uses a user name as the user identifier. Needless to say, the user identifier is not limited to this, and the method for identifying a user may be the serial number of an IC card or the like.

The panel application 407 executes preprocessing to acquire the IP address of the print server 101 before requesting a print job list of the print server 101. First, the panel application 407 transmits a user name as the user identifier to the address management service 405 in the address management server 103 (2-1). The address management service 405 refers to the address management DB 406 to acquire the IF address of a print server 101 corresponding to the received user name (2-2). Then, the address management service 405 sends back the acquired IP address of the print server 101 to the panel application 407 of the multi-function peripheral 102 (2-3).

Upon receiving the IP address of the print server 101 from the address management server 103, the panel application 407 requests a print job list of the job management service 403 in a print server 101 corresponding to the IP address (2-4). The job management service 403 refers to the job management DB 404 (2-5), and generates a print job list, corresponding to the user name. As a response to the request, the job management service 403 sends back the generated print job list to the panel application 407 (2-6). Upon receiving the print job list from the job management service 403 of the print server 101, the panel application 407 displays the print job list on the UI of the operation unit 308.

When the user selects a print job from the print job list displayed on the operation unit 308 and issues a print setting change instruction, the panel application 407 transmits the print settings of the selected print job to the job management service 403 (3-1). Upon receiving the print settings from the panel application 407, the job management service 403 refers to the job management DB 404 (3-2), and changes the print settings. Then, the job management service 403 sends back the changed, print settings to the panel application 407 (3-3). The panel application 407 compares the transmitted print settings with the received print settings, and determines whether the print settings have been changed properly. If the print settings have not been changed properly, a message indicative of this is displayed on the UI of the operation unit 308.

based on an instruction from the user, the panel application 407 issues again a print request (output instruction) to the job management service 403 (4-1). Upon receiving the print request from the panel application 407, the job management service 403 refers to the job management DB 404 and acquires information necessary to print (4-2). Then, the job management service 403 issues a print instruction to a printer driver 408 using the acquired instruction (4-3). The printer driver 408 executes print processing based on the received print instruction, and transmits the PDL job to the multi-function peripheral 102 (4-4). The multi-function peripheral 102 performs print processing for the PDL job received from the print server.

Finally, when the user designates deletion of a print job, the panel application 407 instructs the job management service 403 of the print server 101 to delete the designated print job (5-1). Upon receiving the print job deletion request from the panel application 407, the job management service 403 instructs the address management service 405 of the address management server 103 to delete a registered print job identifier (5-2). Upon receiving the print job identifier registration release request from the job management service 403, the address management service 405 deletes a corresponding record among records stored in the address management DB 406 (5-3). The job management service 403 deletes a corresponding record from the job management DE 404, and deletes even an EMFSPOOL print job file (5-4).

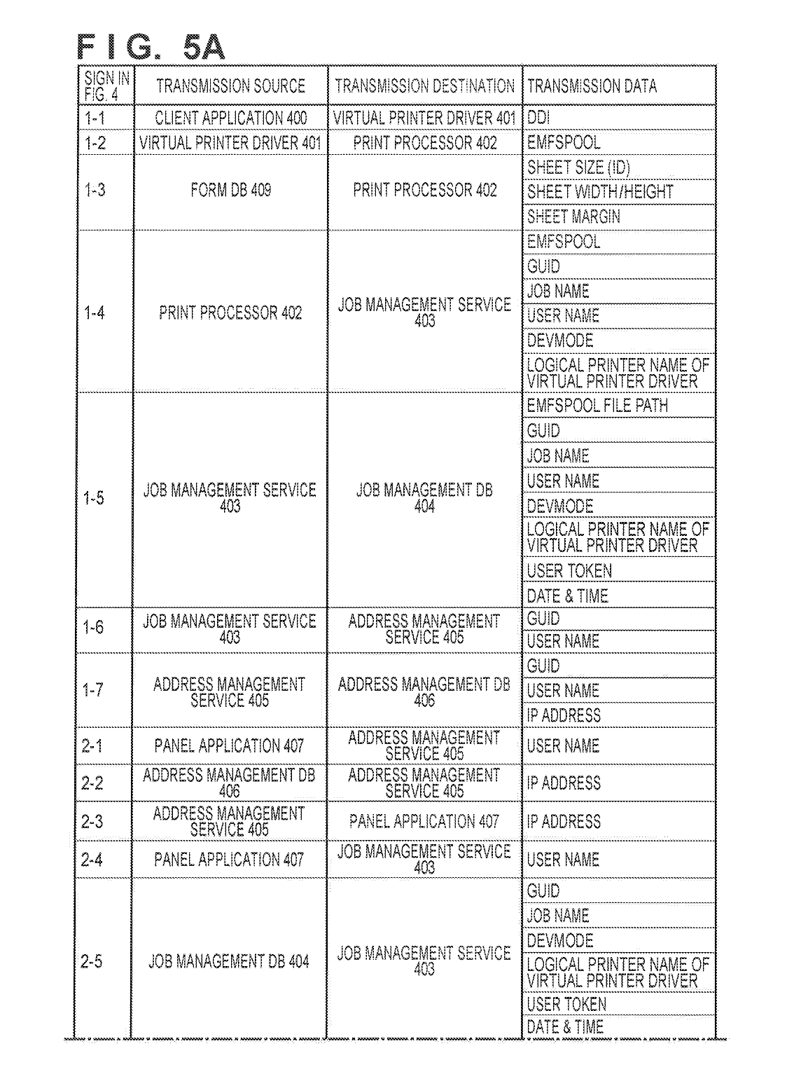

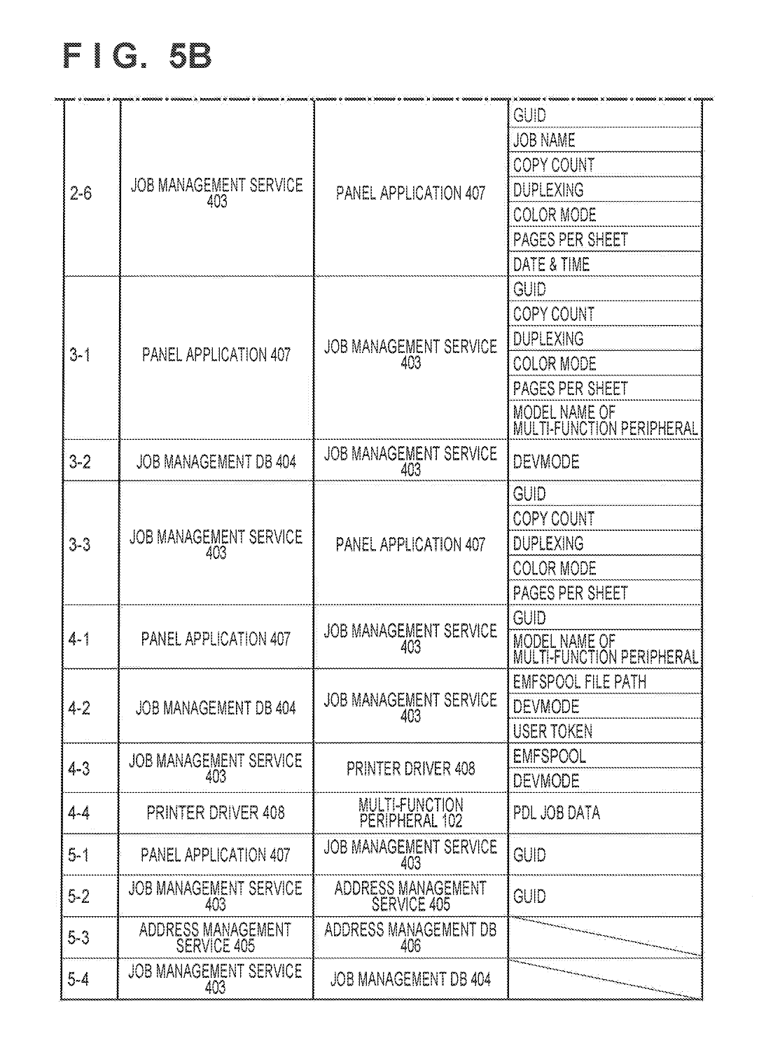

The overall pull print sequence has been described. FIGS. 5A and 5B show details of data used in the printing system of FIG. 4 in the table form. In FIGS. 5A and 5B, correspondence with FIG. 4, data transmission/reception devices, and data contents are defined in correspondence with each other. Processing will be described in detail with reference to flowcharts. At this time, the description will be complemented using FIGS. 5A and 5B.

[Print Instruction Processing]

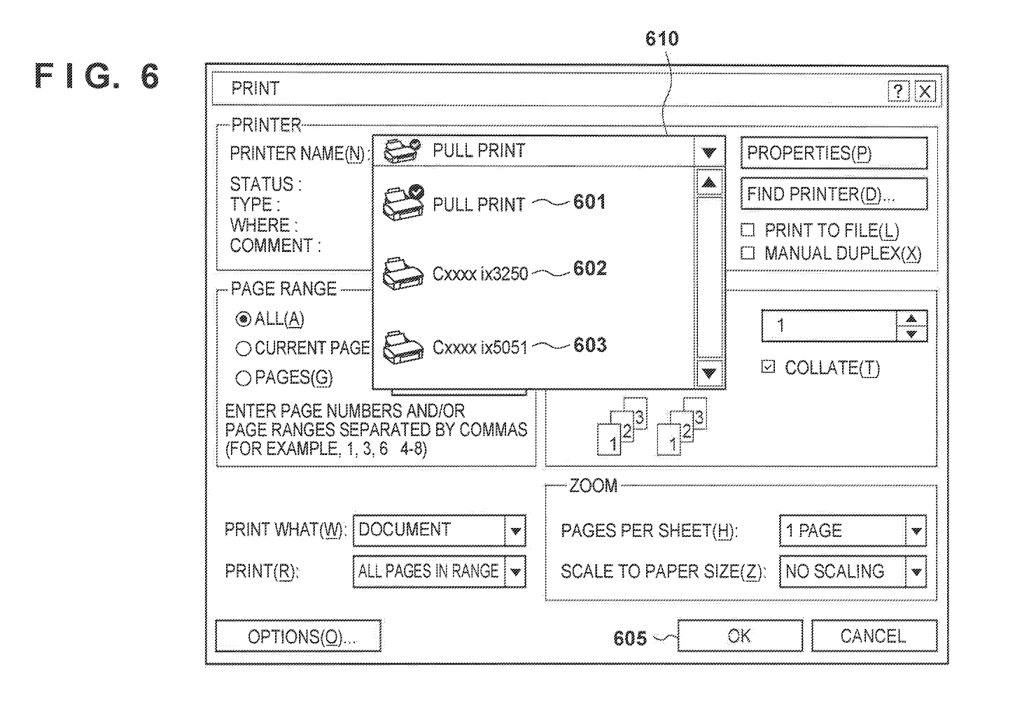

A print instruction in the client application 400 running on the client PC 100 shown in FIG. 1 will be explained. FIG. 6 is a schematic view exemplifying the printing screen of the client application 400 running on the client PC 100 shown in FIG. 1. The display unit displays the printing screen under the control of the CPU of the client PC 100.

A printer selection field 610 allows the user to select a logical printer to print from logical printers set in the client PC 100. In the printer selection field 610, “pull print” 601 is a logical printer corresponding to the virtual printer driver 401 set for pull print in the embodiment. Further, “Cxxxx ix3250” 602 and “Cxxxx ix5051” 603 are logical printers corresponding to normal printer drivers of printers connected to the LAN and the like. The user selects one logical printer in the printer selection field 610, and presses an OK button 605. The client application 400 then transmits print data via the graphic engine to a printer driver corresponding to the selected logical printer. The operation of the printer driver when the user selects the “pull print” 601 in the printer selection field 610 and issues a print instruction will be explained.

[First Control Processing Sequence]

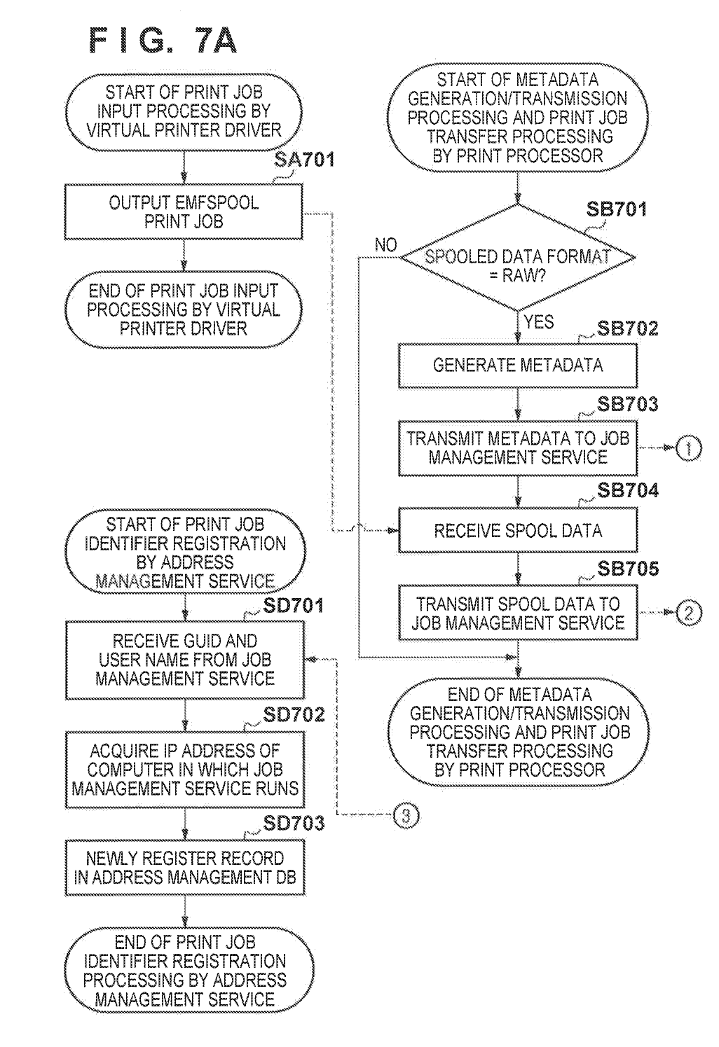

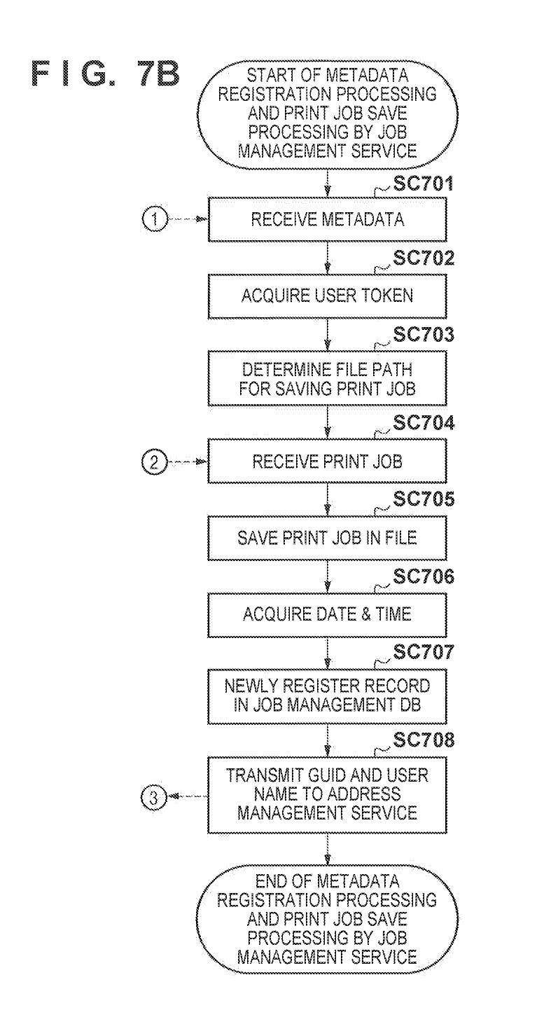

FIGS. 7A and 7B are flowcharts exemplifying the first control processing sequence in the printing system according to the embodiment. This sequence corresponds to the processing sequence from 1-1 to 1-7 shown in FIG. 4. In FIGS. 7A and 7B, broken arrows indicate a data flow between apparatuses. This also applies to all the drawings to be described later.

Processes denoted by SA correspond to print job input processing by the virtual printer driver 401 shown in FIG. 4. These flowchart processes are implemented by loading a program stored in the external memory into the RAM and executing it by the CPU of the client PC 100 shown in FIG. 1.

Processes denoted, by SB correspond to metadata generation/transmission processing and print job transfer processing by the print processor 402 shown in FIG. 4. These flowchart processes are implemented by loading a program stored in the external memory into the RAM and executing it by the CPU of the client PC 100 shown in FIG. 1.

Processes denoted by SC correspond to metadata registration processing and print job save processing by the job management service 403 shown in FIG. 4. These flowchart processes are implemented by loading a program, stored in the external memory into the RAM and executing it by the CPU of the print server 101 shown in FIG. 1.

Processes denoted by SD correspond to print job identifier registration processing by the address management service 405 shown in FIG. 4. These flowchart processes are implemented by loading a program stored in the external memory into the RAM and executing it by the CPU of the address management server 103 shown in FIG. 1.

First, print job input processing by the virtual printer driver 401 will be explained. After the start of processing by the virtual printer driver 401, the virtual printer driver 401 outputs data input from the client application 400 as an EMFSPOOL print job in step SA701. This corresponds to 1-1 and 1-2 in FIG. 4. For Windows® available from Microsoft, USA, input to the virtual printer driver 401 is executed by a so-called DDI (Device Driver Interface) function call by the OS.

The virtual printer driver 401 interprets a parameter transferred, at the same time as the DDI call, generates an EMFSPOOL print job, and outputs the generated print job to a spooler managed by the OS. In general, the role of the printer driver is to generate and output an output device-dependent print job. In the embodiment, a print job of an intermediate data format independent of the printer device (multi-function, peripheral 102) is generated and output. Hence, even if the arrangement of the multi-function peripheral 102 to output data is changed, that of the virtual printer driver 401 does not change in the printing system according to the embodiment. That is, the embodiment facilitates the use of a function specific to the multi-function peripheral 102 in the pull print system. The process then ends.

Next, metadata generation/transmission processing and print job transfer processing by the print processor 402 will be explained. For Windows® available from Microsoft, USA, internal processing by a PrintDocumentOnPrintProcessor function called when the OS requests the print processor 402 to process a print job will be described. After the start of processing on the client PC 100, the print processor 402 determines in step SB701 whether the type of job output to the spooler of the OS is the RAW format. The RAW format indicates a print job output from the printer driver. Since the virtual printer driver 401 has output the print job in step SA701, the print job has the RAW format. The print processor 402 determines that the job type is the RAW format (YES in step SB701), and the process advances to step SB702. If the print processor 402 determines that the job type is not the RAW format (NO in step SB701), the process ends.

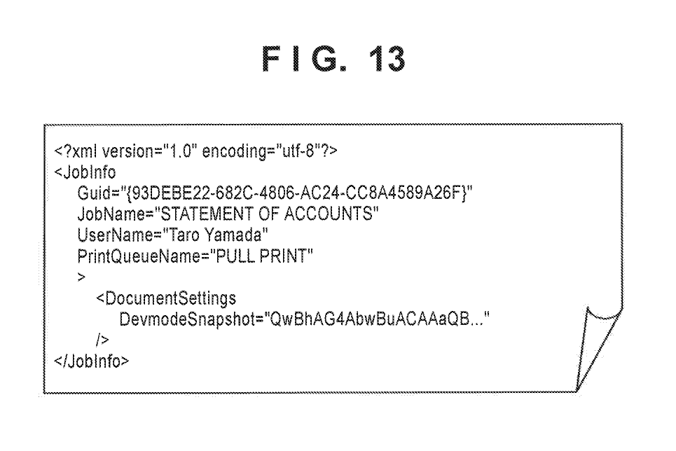

In step SB702, the print processor 402 generates metadata. Metadata includes the GUID (Global Unique Identifier), the job name, the user name, the DEVMODE, and the logical printer name of the virtual printer driver on the “transmission data” column on the “1-4” row in FIG. 5A. More specifically, the metadata is expressed in the XML format as shown in FIG. 13. The Guid attribute of the JobInfo element describes a print job identifier which is unique in the printing system according to the embodiment. The JobName attribute of the JobInfo element describes the name of a job designated, in process 1-1 of FIG. 4. The Username attribute of the JobInfo element describes the name of a user who printed in process 1-1 of FIG. 4. The PrintQueueName attribute of the JobInfo element describes the name of a logical printer used in process 1-1 of FIG. 4. The DEVMODESnapshot attribute of the DocumentSettings element describes the print setting (DEVMODE) of the first page designated in process 1-1 of FIG. 4. Note that the DEVMODE is a binary format, and is converted into a text by a Base64 method to describe data by XML.

In step SB703, the print, processor 402 transmits the metadata generated in step SB702 to the job management service 403. For Windows® available from Microsoft, USA, it is efficient to use a named pipe as a transmission protocol. The use of the named pipe is convenient even for acquisition of a user token (to be described later). In step SB704, the print processor 402 loads spool data from the spooler of the OS. In step SB705, the print processor 402 transmits the loaded spool data to the job management service 403. The process then ends.

Metadata registration processing and print job save processing by the job management service 403 will be described. After the start of processing by the job management service 403, the job management service 403 functions as a named pipe server and receives the metadata transmitted, from the print processor 402 in step SB703 in the XML format as shown in FIG. 13 in step SC701. When establishing a connection with the print processor 402, the job management service 403 acquires the user token of a named pipe client (that is, the print processor 402) (step SC702). The usage of the acquired user token will be described later.

In step SC703, the job management service 403 determines a file path for saving the print job. In step SC704, the job management service 403 receives the EMFSPOOL print job transmitted from the print processor 402 in step SB705. In step SC705, the job management service 403 saves the received EMFSPOOL print job with the file name determined in step SC703. In step SC706, the job management service 403 generates the current date & time information. The generated date & time information is set as the print job input time.

In step SC707, the job management service 403 registers, as a new record in the job management DB 404, the metadata received, in step SC701, the user token acquired in step SC702, the file name determined in step SC703, and the date & time generated in step SC706. In step SC708, the job management service 403 transmits a print job identifier registration command to the address management service 405. At this time, the job management service 403 also transmits the GUID and user name contained in the metadata received in step SC701. Then, the process ends.

Print job identifier registration processing by the address management service 405 will be explained. After the start of processing by the address management service 405, the address management service 405 receives, in step SD701, the GUID and user name transmitted from the job management service 403 in step SC708. When establishing a connection with the job management, service 403, the address management service 405 acquires the IP address of the print server 101 (step SD702). In step SD703, the address management service 405 registers, as a new record in the address management DB 406 of FIG. 4, the QUID and user name received in step SD701 and the IP address acquired in step SD702 in association with each other. The process then ends.

[Second Control Processing Sequence]

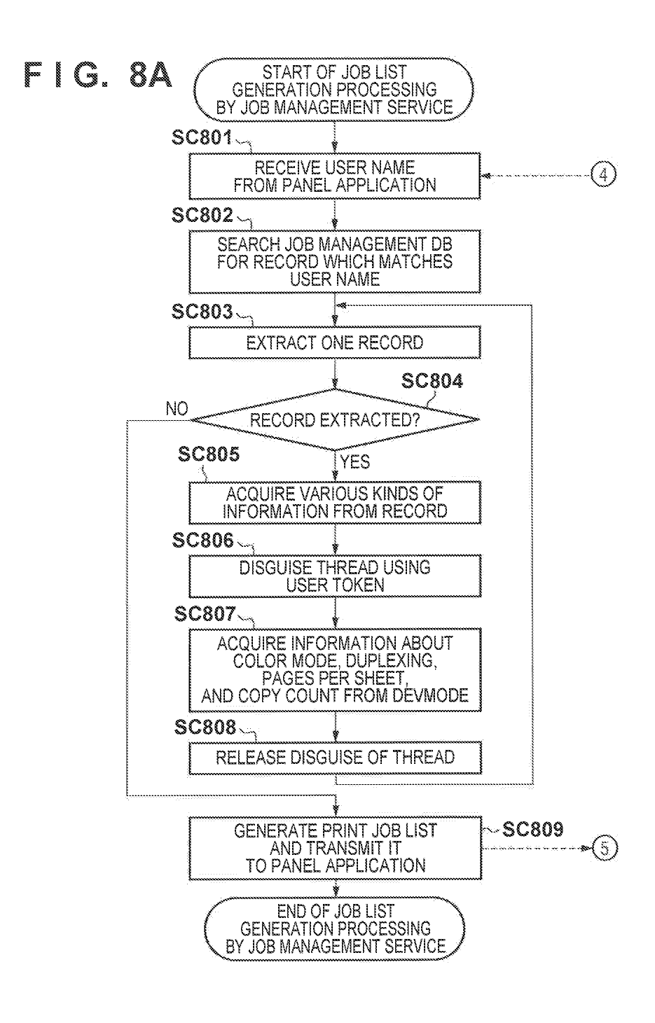

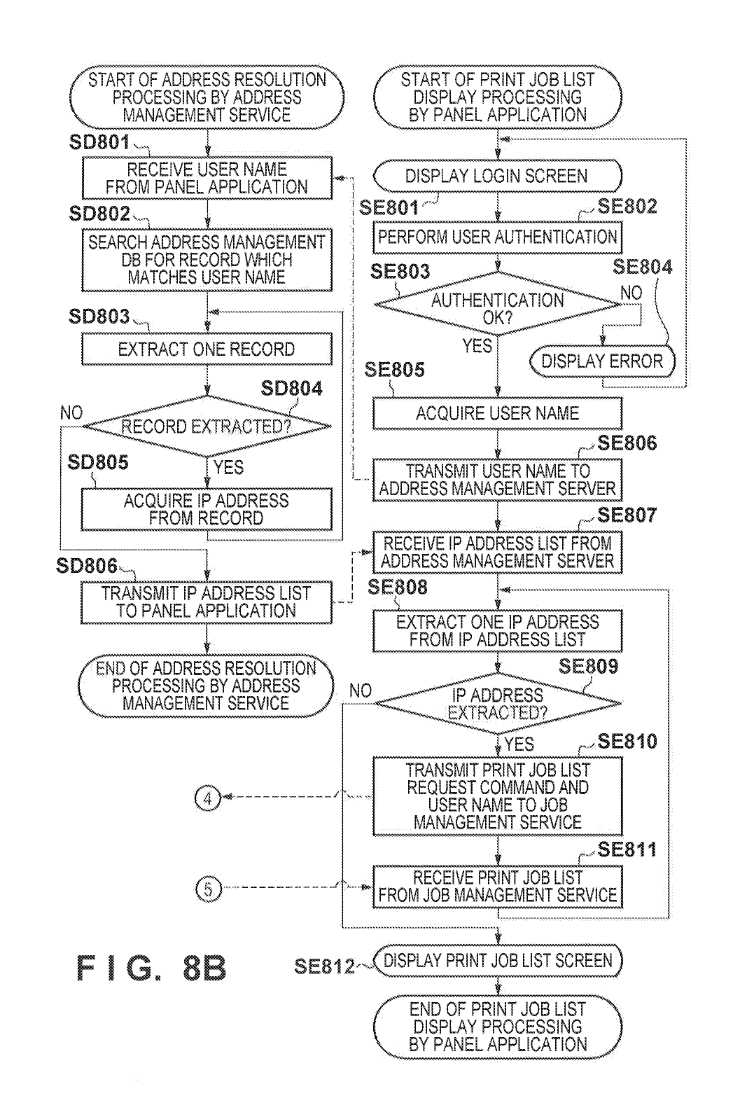

FIGS. 8A and 8B are flowcharts exemplifying the second, control processing sequence in the printing-system according to the embodiment. This sequence corresponds to the processing sequence from 2-1 to 2-6 shown in FIG. 4.

Processes denoted by SE correspond to print, job list display processing by the panel application 407 shown, in FIG. 4. These flowchart processes are implemented by loading a program stored in the external memory into the RAM and executing it by the CPU of the multi-function peripheral 102 shown in FIG. 1.

Processes denoted, by SD correspond to address resolution processing by the address management service 405 shown in FIG. 4. These flowchart processes are implemented by loading a program stored in the external memory into the RAM and executing it by the CPU of the address management server 103 shown in FIG. 1.

Processes denoted by SC correspond to print job list generation, processing by the job management service 403 shown in FIG. 4. These flowchart processes are implemented by loading a program stored in the external memory into the RAM and executing it by the CPU or the print server 101 shown in FIG. 1.

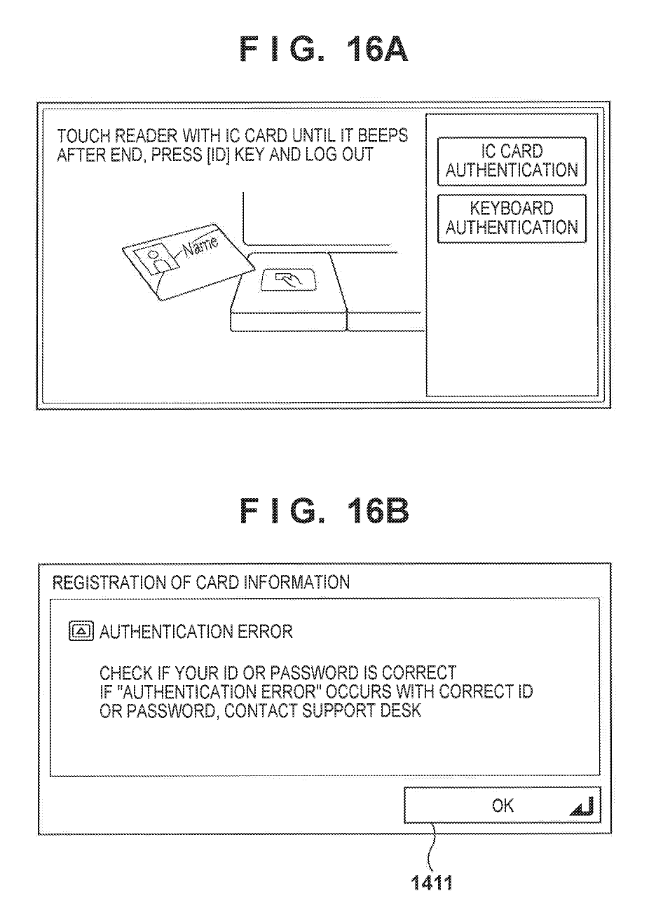

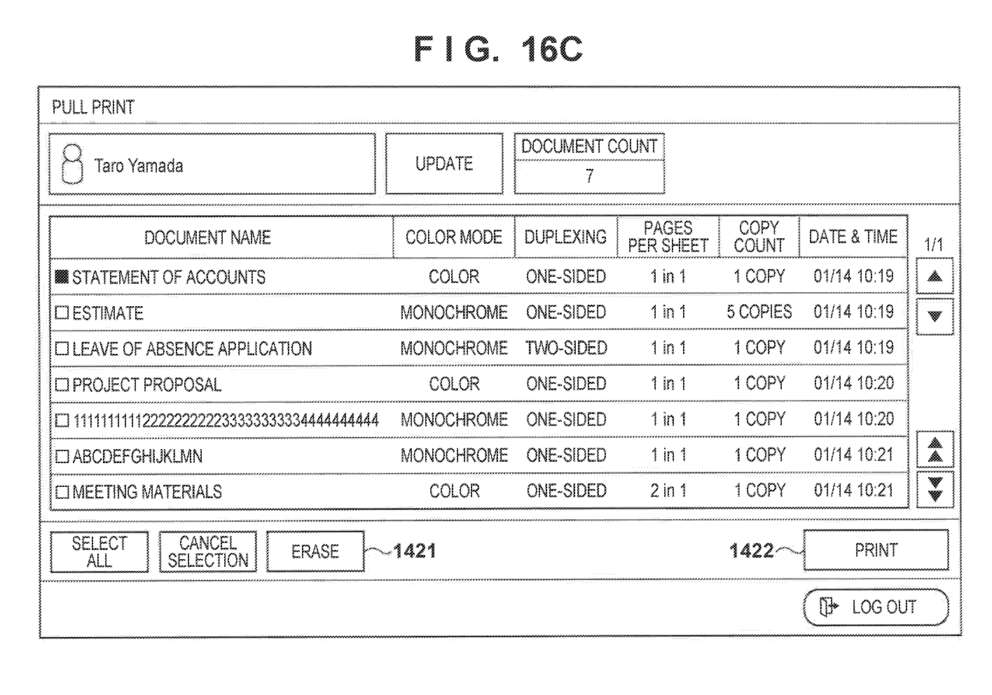

First, print job list display processing by the panel application 407 will be explained. After the start of processing by the panel application 407, the panel application 407 controls in step SE801 to display a login display screen (FIG. 16A) on the display unit of the operation unit 308. In step SE802, the panel application 407 performs user authentication based on an IC card or the like. In the embodiment, user authentication is not an important process, so a detailed description of an authentication card, detection method, an IC card identification ID acquisition method, and authentication processing by an authentication server will be omitted.

In step SE803, the panel application 407 determines the authentication result. If the panel application 407 obtains an authentication result indicating an authentication error (NO in step SE803), it controls in step SE804 to display an error display screen (FIG. 16B) on the display unit of the operation unit 308. If the panel application 407 accepts pressing of an OK button 1411 on the error display screen, the process returns to step SE801 and the panel application 407 controls to display the login display screen again. If the panel application 407 determines in step SE803 that authentication has succeeded (YES in step SE803), the process advances to step SE805. In step SE805, the panel application 407 acquires the name of a user who has been authenticated successfully.

In step SE806, the panel application 407 transmits the user name acquired in step SE805 to the address management server 103. In step SE807, the panel application 407 receives the IP address list of the print server 101 from the address management service 405. More specifically, the panel application 407 requests the address management service 405 to narrow down print jobs corresponding to the user name, and send back IP addresses of the job management service 403 where the print jobs are held.

Subsequent steps SE808 to SE811 are loop processing of listing IP addresses from the IP address list. In step SE808, the panel application 407 extracts one IP address from, the IP address list. In step SE809, the panel application 407 determines whether an IP address has been extracted. If an IP address has been extracted (YES in step SE809), the process advances to step SE810. In step SE810, the panel application 407 transmits a print job list request command as a print job list request signal to the job management service 403. At this time, the panel application 407 transmits the user name, too.

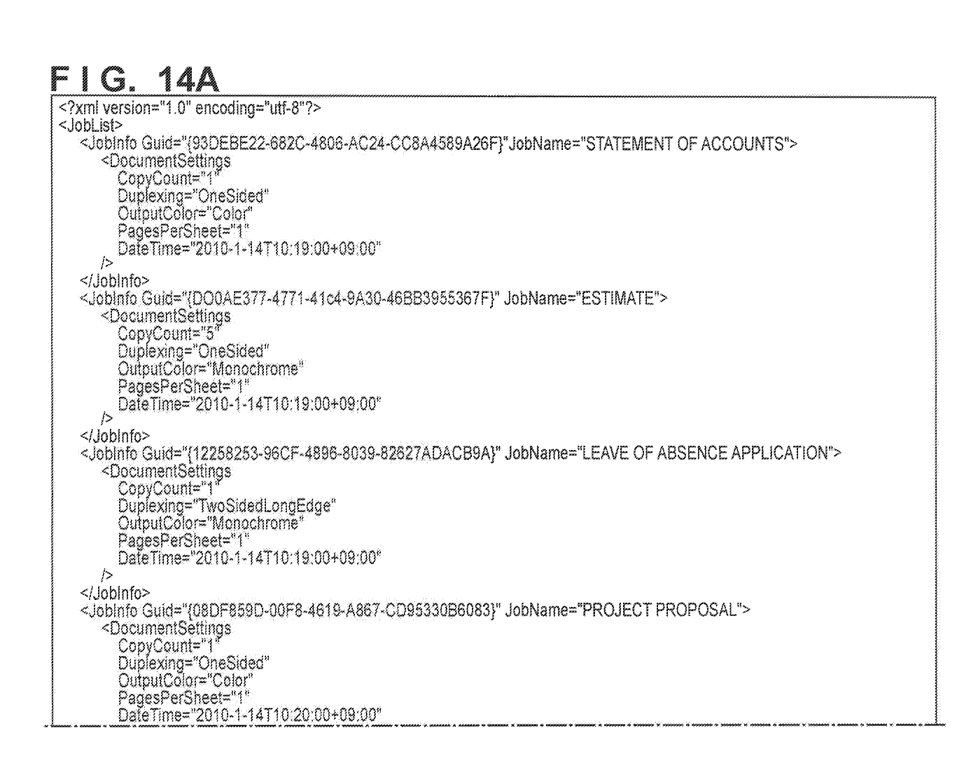

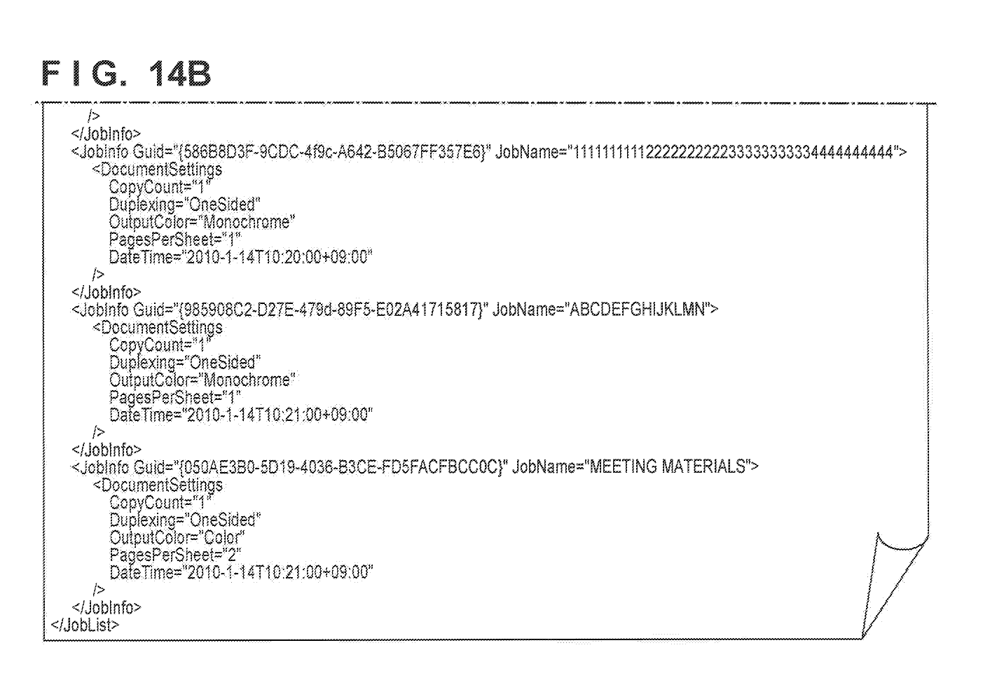

In step SE811, the panel application 407 receives a print job list from the job management service 403. The print job list received here contains information about, the GUID, job name, copy count, duplexing, color mode, pages per sheet, and date & time on the “transmission data” column, on the “2-6” row in FIG. 5B. More specifically, the print job list is expressed in the XML format as shown in FIGS. 14A and 14B. The JobList element holds JobInfo child elements by the number of jobs. The Guid attribute of the JobInfo element is the same as Guid described with reference to FIG. 13. The JobName attribute of the JobInfo element is also the same as JobName described with reference to FIG. 13.

To the contrary, various attributes held by the DocumentSettings element greatly differ from those in FIG. 13. The CopyCount attribute designates the number of copies. The Duplexing attribute designates which of one-sided printing and two-sided printing is used. More specifically, a description “OneSided” designates one-sided printing. A description “TwoSidedLongEdge” designates two-sided (long-edge binding). A description “TwoSidedShortEdge” designates two-sided (short-edge binding). The OutputColor attribute designates an output method regarding color. A description “Color” designates color. A description “Monochrome” designates monochrome. The PagesPerSheet attribute designates the number of pages which can be selected for printing on one surface of a sheet. The DateTime attribute designates the job input time.

After the panel application 407 ends extraction of an IP address from the IP address list, in steps SE808 to SE811 (NO in step SE809), the process advances to step SE812. The panel application 407 controls to display a print job list display screen (FIG. 16C) on the display unit of the operation unit 308. Then, the process ends,

Next, address resolution processing by the address management service 405 will be explained. After the start of processing by the address management service 405, the address management service 405 receives, in step SD801, the user name transmitted from the panel application 407 in step SE806. In step SD802, the address management service 405 searches the address management DB 406 shown in FIG. 4 for a record which matches the user name received in step SD801.

In step SD803, the address management service 405 extracts one record from detected records. In step SD804, the address management service 405 determines whether the record has been extracted. If the record has been extracted (YES in step SD804), the process advances to step SD805. In step SD805, the address management service 405 acquires, from the extracted record, the IP address of the print server 101 in which the job management service 403 runs. After the end of extracting IP addresses from all detected records in steps SD803 to SD805 (NO in step SD804), the process advances to step SD806. The address management service 405 sends back the IP address list to the panel application 407. The process then ends.

Print job list generation processing by the job management service 403 will be explained. After the start of processing by the job management service 403, the job management service 403 receives, in step SC801, the print, job list request transmitted from the panel application 407 in step SE810. At this time, the job management service 403 receives the user name, too. In step SC802, the job management service 403 searches the job management DB 404 in FIG. 4 for a record which matches the user name received in step SC801. In step SC803, the job management service 403 extracts one record from detected records.

In step SC804, the job management service 403 determines whether the record has been extracted. If the record has been extracted (YES in step SC804), the process advances to step SC805. In step SC805, the job management service 403 extracts a GUID, a job name, a DEVMODE, the logical printer name of a virtual printer driver, a user token, and date & time from the record. In step SC806, the job management service 403 disguises its thread, using the user token obtained in step SC804. “Disguise” indicates that the job management service 403 performs processing, execution of which is permitted for the user, by using not an originally assigned right but an acquired user token right. While the thread is disguised, it is executed in the security context of a user who has executed a print instruction using the client application 400 of FIG. 4.

In step SC807, the job management service 403 extracts pieces of information such as the color-mode, duplexing, pages per sheet, and copy count from the DEVMODE obtained in step SC805. The DEVMODE is a printer driver-specific data format managed by the printer driver. To extract pieces of information from the DEVMODE, an inquiry need to be made to a printer driver which has generated the DEVMODE. Since a logical printer name corresponding to the virtual printer driver has been acquired in step SC807, pieces of information are extracted from the DEVMODE based on the logical printer name. In general, pieces of information are extracted from the DEVMODE via a unique expansion interface which is arranged in the printer driver to operate the DEVMODE. Recently, there is a method using an XML print setting storage format called a print ticket defined by Microsoft, USA. If the printer driver supports the print ticket, it is also possible to convert the DEVMODE into a print ticket and extract pieces of information from the print ticket. However, the present invention is not limited to this

In step SC808, the job management, service 403 releases the disguise of the thread. After the end of extracting print settings from all detected records in steps SC803 to SC808 (NO in step SC804), the process advances to step SC809. The job management service 403 generates a print job list (FIGS. 14A and 14B). The job management service 403 sends back the print job list to the panel application 407. The process then ends.

Note that the layouts of the screens shown in FIGS. 16A to 16C used in the above processing are merely examples, and the screens are not limited, to them. A screen having another layout is also available.

[Third Control Processing Sequence]

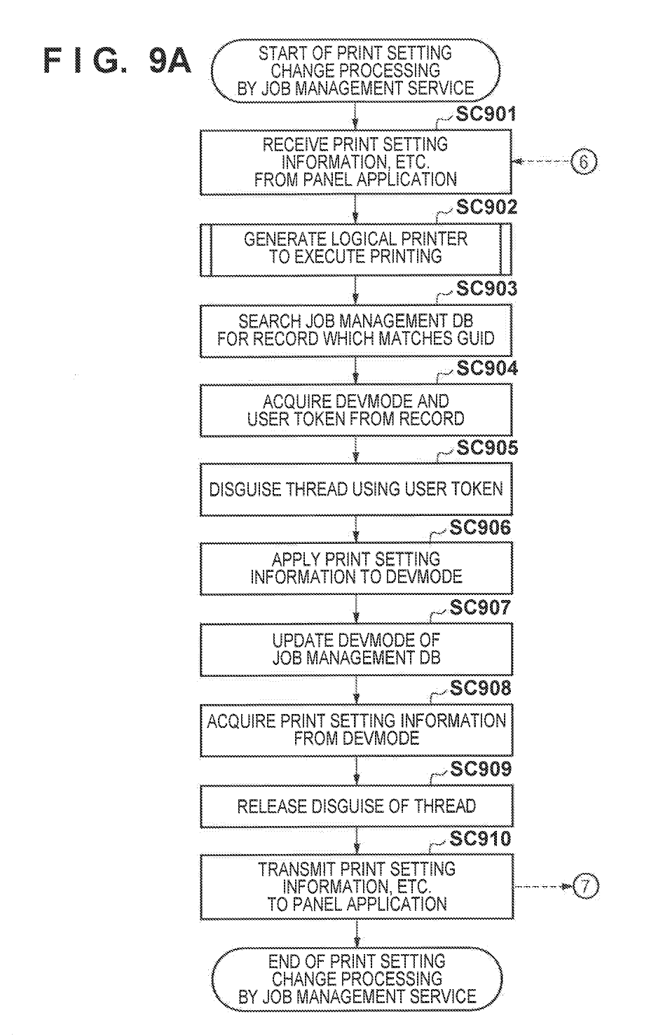

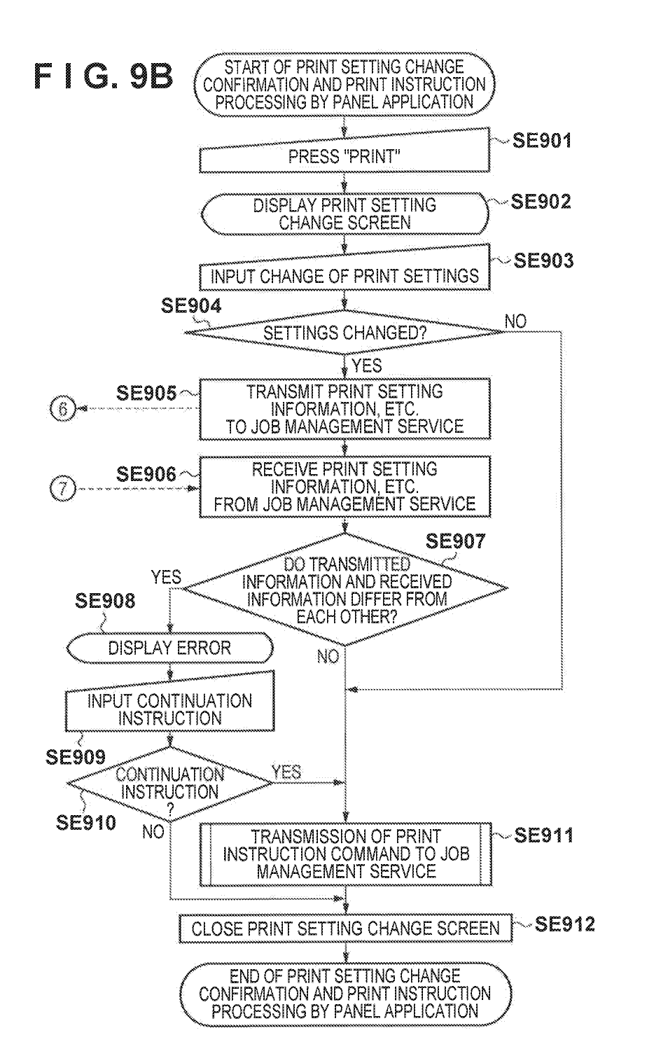

FIGS. 9A and 9E are flowcharts exemplifying the third control processing sequence in the printing system according to the embodiment. This sequence corresponds to the processing sequence from 3-1 to 3-3 shown in FIG. 4.

Processes denoted by SE correspond to print setting change confirmation and print instruction processing by the panel application 407 shown in FIG. 4. These flowchart processes are implemented by loading a program stored in the external memory into the RAM and executing it by the CPU of the multi-function peripheral 102 shown in FIG. 1.

Processes denoted by SC correspond to print setting change processing- by the job management service 403 shown in FIG. 4. These flowchart processes are implemented by loading a program stored in the external memory into the RAM and executing it by the CPU of the print server 101 shown in FIG. 1.

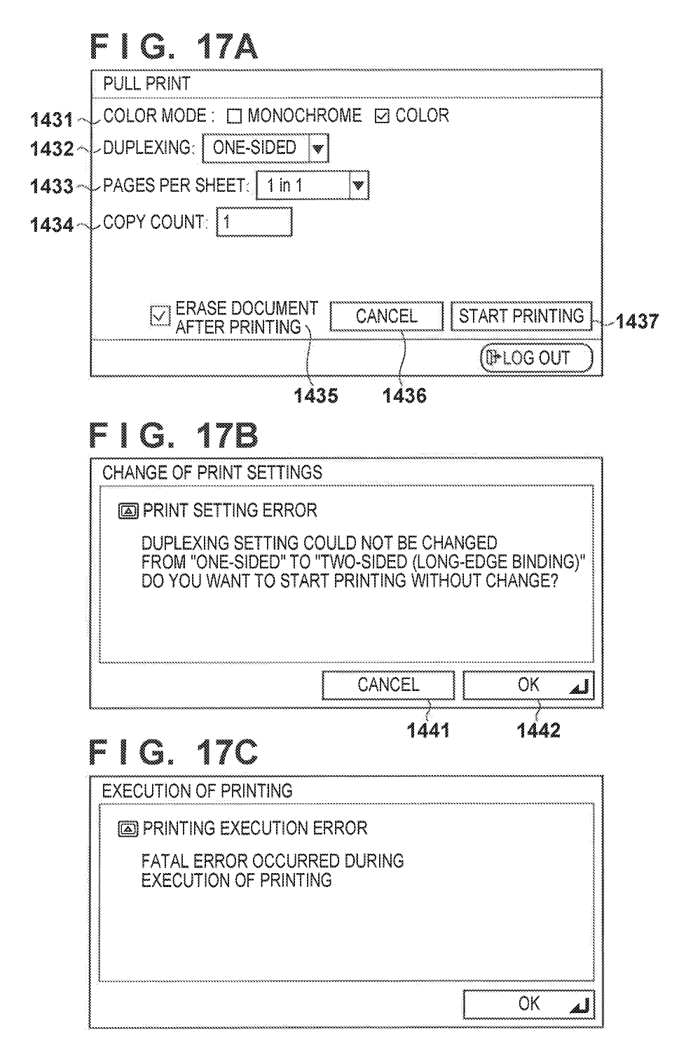

First, print setting change confirmation and print instruction processing by the panel application 407 will be explained. In step SE812 of FIG. 8B, it is controlled to display the print job list display screen (FIG. 16C) on the display unit of the operation unit 308. After the start of processing by the panel, application 407, the panel application 407 accepts selection of a print job and pressing of a print, button 1422 via the print job list display screen in step SE901. In step SE902, the panel application 407 controls to display a print setting change screen (FIG. 17A) on the display unit of the operation unit 308. On the print setting change screen shown in FIG. 17A, a setting items 1431 accepts designation of a color mode and allows the user to check either monochrome or color. A setting items 1432 accepts designation of two-sided/one-sided, and allows the user to select one of one-sided, two-sided (long-edge binding), and two-sided (short-edge binding). A setting item 1433 accepts designation of pages per sheet, and allows the user to select one of 1in1, 2in1, 4in1, 6in1, 8in1, 9in1, and 16in1, A setting item 1434 accepts designation of the copy count, and allows the user to designate a value of 1 to 9,999. A screen shown in FIG. 17A is a print setting change screen upon accepting selection of a print job with a document name “statement of accounts” in FIG. 16C and pressing of the “print” button 1422. Note that the setting items and setting contents are not limited to the above-mentioned contents; and can be changed in accordance with the function and state of a device (multi-function peripheral 102) used in printing.

In step SE903, the panel application 407 accepts a designated print setting change. Assume that the user has changed the two-sided/one-sided designation of the setting item 1432 in FIG. 17A from “one-sided” to “two-sided (long-edge binding)”. In step SE904, the panel application 407 determines whether the print setting has been changed. If no print setting has been changed (NO in step SE904), the process advances to step SE911. If the print setting has been changed (YES in step SE904), the process advances to step SE905.

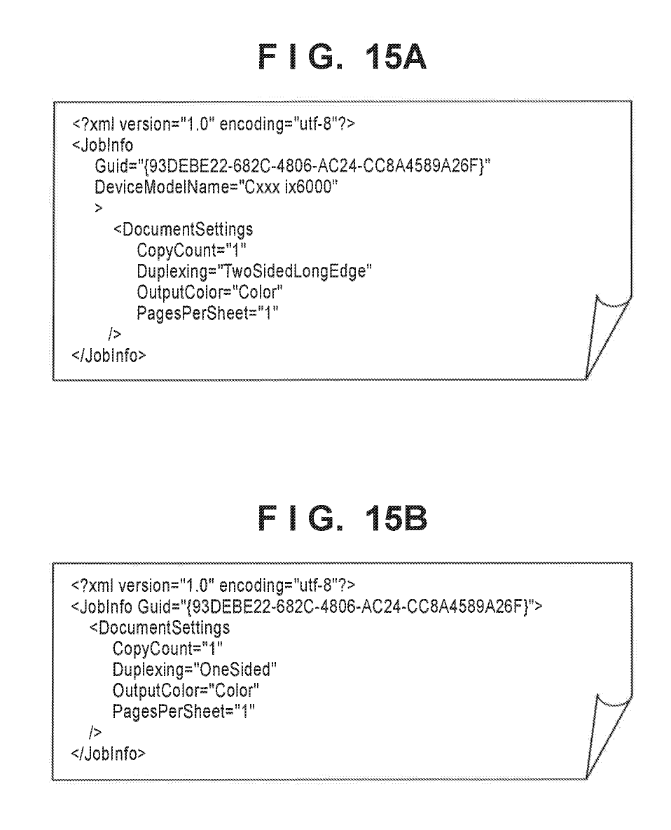

In step SE905, the panel application 407 transmits the changed print setting information to the job management service 403 of the print server 101. The print setting information includes the GUID, copy count, duplexing, color mode, pages per sheet, and multi-function peripheral model name on the “transmission data” column on the “3-1” row in FIG. 5B. More specifically, the print, setting information is expressed in the XML format as shown in FIG. 15A. The Guid attribute of the JobInfo element is the same as Guid described with reference to FIG. 13. The DeviceModelName attribute of the JobInfo element describes the model name of the multi-function peripheral 102 in FIG. 1. Various attributes held by the DocumentSettings element are the same as those described with reference to FIGS. 14A and 14B. However, the setting has been changed, from “one-sided” to “two-sided (long-edge binding)” in step SE903, so the Duplexing attribute becomes “TwoSidedLongEdge”. As a print setting change request, a print setting change instruction is issued.

In step SE906, the panel, application 407 receives, from the job management service 403, print setting information which reflects the print setting change instruction. The print setting information includes the GUID, copy count, duplexing, color mode, and pages per sheet on the “transmission data” column on the “3-3” row in FIG. 5B. More specifically, the print setting information is expressed in the XML format as shown in FIG. 15B. The contents are almost the same as those in FIG. 15A, and a description thereof will not be repeated.

In step SE907, the panel application 407 compares the print setting information transmitted in step SE905 with one received in step SE906. As described above, the Duplexing attribute in the print setting information transmitted in step SE905 designates “TwoSidedLongEdge”. However, assume that the Duplexing attribute in the print setting information received in step SE906 is “OneSided”. Such a mismatch between transmitted and received settings is highly likely to occur in principle. Setting information which is not changed in step SE903 is, for example, the sheet, size. Assume that the sheet size is “postcard” in step 1-1 of FIG. 4. As a print setting prohibition condition, assume that two-sided/one-sided, designation allows selection of only “one-sided” for a sheet “postcard”. Further, the priority to apply the prohibition condition is higher for sheet size designation than for two-sided/one-sided designation. In this case, the Duplexing attribute has to always be “OneSided”.

If the same advanced, prohibition processing as that, of the printer driver is implemented in the panel application 407, a change of duplexing designation can be prohibited in input of a setting change on the screen shown in FIG. 17A. However, the use of this method greatly complicates implementation of the panel application 407, It is therefore easy and versatile to inquire of the printer driver whether a change is possible every time a print setting is changed, without, performing print setting prohibition processing by the panel application 407, as in the embodiment.

If the print setting information transmitted in step SE905 and one received in step SE906 are identical as a result of comparison (NO in step SE907), the process advances to step SE911. If they are different (YES in step SE907), the process advances to step SE908, and the panel application 407 controls to display an error display screen (FIG. 17B) on the display unit of the operation unit 308. Since the Duplexing attribute of the print setting received in step SE906 is “OneSided”, the error display screen shown in FIG. 17B represents that a change from “one-sided” to “two-sided (long-edge binding)” has failed.

In step SE909, the panel application 407 accepts input of a print continuation instruction from the user via the display unit. If the panel application 407 accepts pressing of the OK button 1442 on the error display screen shown in FIG. 17B (YES in step SE910), the process advances to step SE911. Print instruction processing in step SE911 will be described later. The process then advances to step SE912. If the panel application 407 accepts pressing of a cancel button 1441 on the error display screen of FIG. 17B (NO in step SE910), the process advances to step SE912. In step SE912, the panel application 407 closes the error display screen shown in FIG. 17B and the print setting change screen shown in FIG. 17A. After that, the process ends.

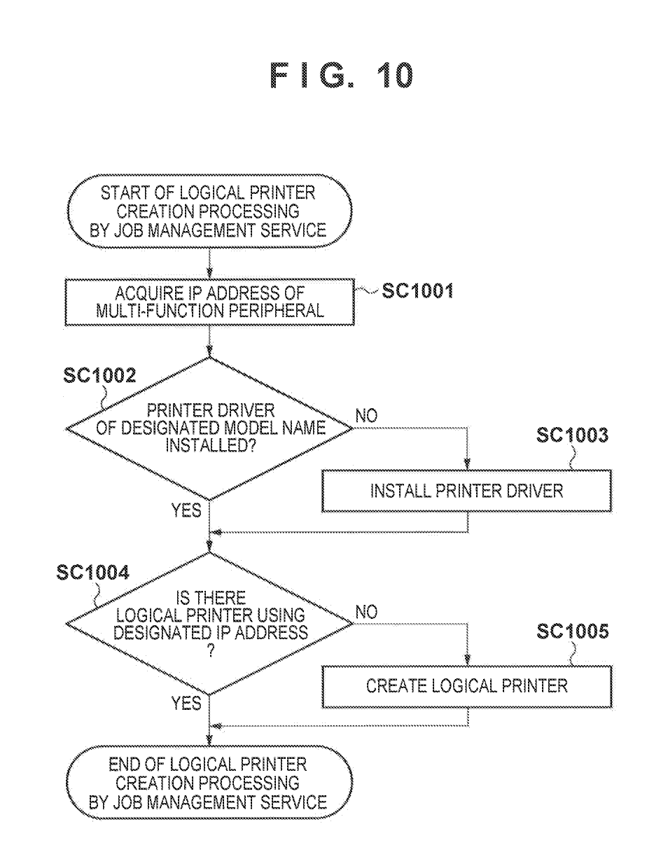

Print setting change processing by the lob management service 403 will be explained. After the start of processing by the job management service 403, the job management service 403 receives, in step SC901, print settings transmitted from the panel application 407 in step SE905 in the XML format, as shown in FIG. 15A. In step SC902, the job management service 403 generates a logical printer for changing a print setting. Details of this processing will be described later with reference to FIG. 10.

In step SC903, the job management service 403 searches the job management DB 404 shown in FIG. 4 for a record which matches the GUID received in step SC901. In step SC904, the job management service 403 acquires a DEVMODE and user token from the detected record. In step SC905, the job management service 403 disguises its thread using the user token acquired in step SC904. While the thread is disguised, it is executed in the security context of a user who printed using the client application 400 in FIG. 4.

In step SC906, the job management service 403 applies print settings received in step SC901 to the DEVMODE acquired in step SC904. The DEVMODE is a printer driver-specific data, format managed by the printer driver. To apply pieces of information to the DEVMODE, a printer driver which has generated the DEVMODE is requested to update the DEVMODE. The logical printer has been generated in step SC902 and is used to apply pieces of information to the DEVMODE using the logical printer. In general, pieces of information are applied to the DEVMODE via a unique expansion interface which is arranged in the printer-driver to operate the DEVMODE. Recently, there is a method using an XML print setting storage format called a print ticket defined by Microsoft, USA. If the printer driver supports the print ticket, it is also possible to convert the DEVMODE into a print ticket, apply pieces of information to the print ticket, and convert the print ticket into a DEVMODE. Note that the present invention is not limited to this method.

In step SC907, the job management service 403 updates the DEVMODE saved in the job management DB 404 using the DEVMODE changed in step SC906. In step SC908, the job management, service 403 extracts pieces of information such, as the color mode, duplexing, pages per sheet, and copy count, from the DEVMODE updated in step SC906. Extraction of pieces of information is the same as that in step SC807 shown in FIG. 8A. In step SC909, the job management service 403 releases the disguise of the thread. In step SC910, the job management service 403 sends back, to the panel application 407, the print setting which has been changed into the XML format as shown in FIG. 15B, The process then ends.

[Logical Printer Generation Processing Sequence]

FIG. 10 is a flowchart showing logical printer generation processing called in step SC902 of FIG. 9A. This processing corresponds to print job list generation processing by the job management service 403 shown in FIG. 4. These flowchart processes are implemented by loading a program stored in the external memory into the RAM and executing it by the CPU of the print server 101 shown in FIG. 1.

After the start of processing by the job management service 403, the job management service 403 acquires the IP address of the multi-function peripheral 102 in FIG. 1 in step SC1001. The IP address of the multi-function peripheral 102 is acquired when a data transmission/reception connection with the panel application 407 is established. In step SC1002, the job management service 403 determines whether a printer driver which supports the model name of the multi-function peripheral 102 in FIG. 1 has already been installed in the print server 101. If no such printer driver has been installed (NO in step SC1002), the process advances to step SC1003, and the job management service 403 installs, in the print server 101, a printer driver which supports the model name of the multi-function peripheral 102 in FIG. 1. The process then advances to step SC1004. If the job management service 403 determines in step SC1002 that such a printer driver has been installed (YES in step SC1002), the process advances to step SC1004. At this stage, the installed printer driver is the printer driver 408 in FIG. 4, and executes various processes in accordance with instructions.

in step SC1004, the job management service 403 determines whether a logical printer which is formed from the installed printer driver and has the IP address acquired in step SC1001 as an output port exists in the print server 101. If no such logical printer exists (NO in step SC1004), the process advances to step SC1005. In step SC1005, the job management service 403 generates a logical printer having the IP address acquired in step SC1001 as an output port by using the installed printer driver. Thereafter, she process ends. If such a logical, printer exists (YES in step SC1004), the process ends.

[Fourth Control Processing Sequence]

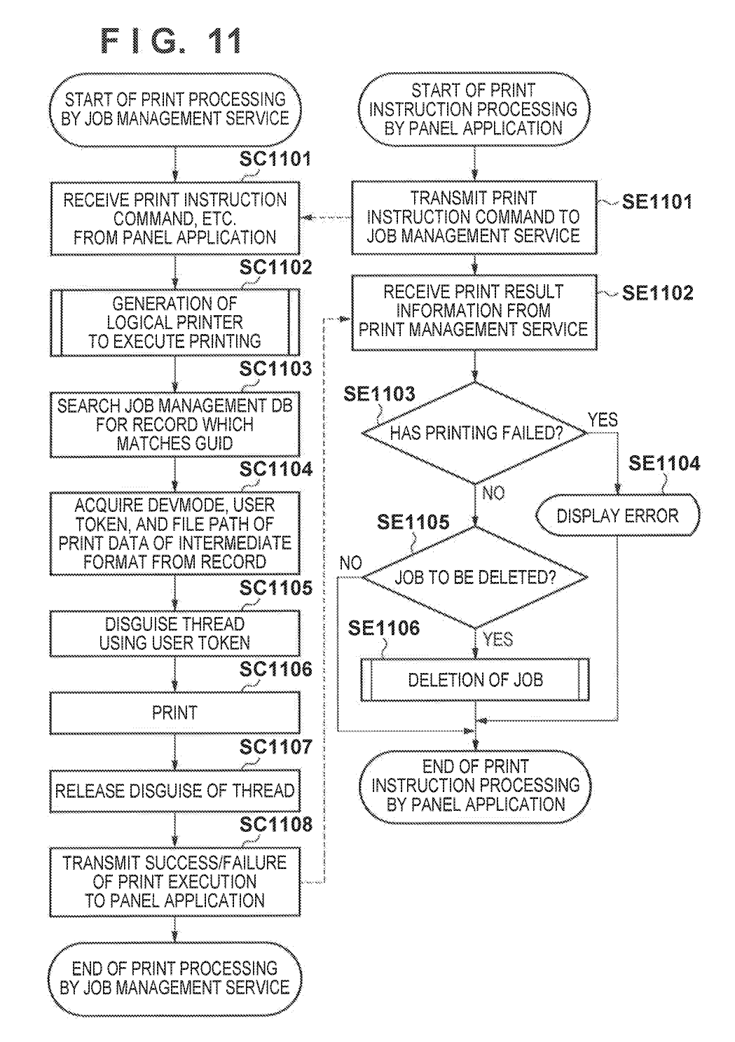

FIG. 11 is a flowchart exemplifying the fourth control processing sequence in the printing system according to the embodiment, and is also a flowchart showing print instruction processing called in step SE911 of FIG. 9B. This sequence corresponds to the processing sequence from 4-1 to 4-4 shown in FIG. 4.

Processes denoted by SE correspond to print instruction processing by the panel application 407 shown in FIG. 4. These flowchart processes are implemented by loading a program stored in the external memory into the RAM and executing it by the CPU of the multi-function peripheral 102 shown in FIG. 1.

Processes denoted by SC correspond to print processing by the job management service 403 shown in FIG. 4. These flowchart processes are implemented by loading a program stored in the external memory into the RAM and executing it by the CPU of the print server 101 shown in FIG. 1.

First, print instruction processing by the panel application 407 will be explained. After the start of processing by the panel application 407, the panel application 407 transmits a print instruction request command as a print instruction signal to the job management service 403 in SE1101. At this time, the panel application 407 also transmits the GUID of a selected print job and the model name of the multi-function peripheral 102. In step SE1102, the panel application 407 receives a print execution result (success/failure) from the job management service 403. In step SE1103, the panel application 407 determines whether execution of printing has succeeded. If execution of printing has failed (YES in step SE1103), the process advances to step SE1104. In step SE1104, the panel application 407 controls to display an error display screen (FIG. 17C) on the display unit of the operation unit 308. The process then advances to step SE1107.

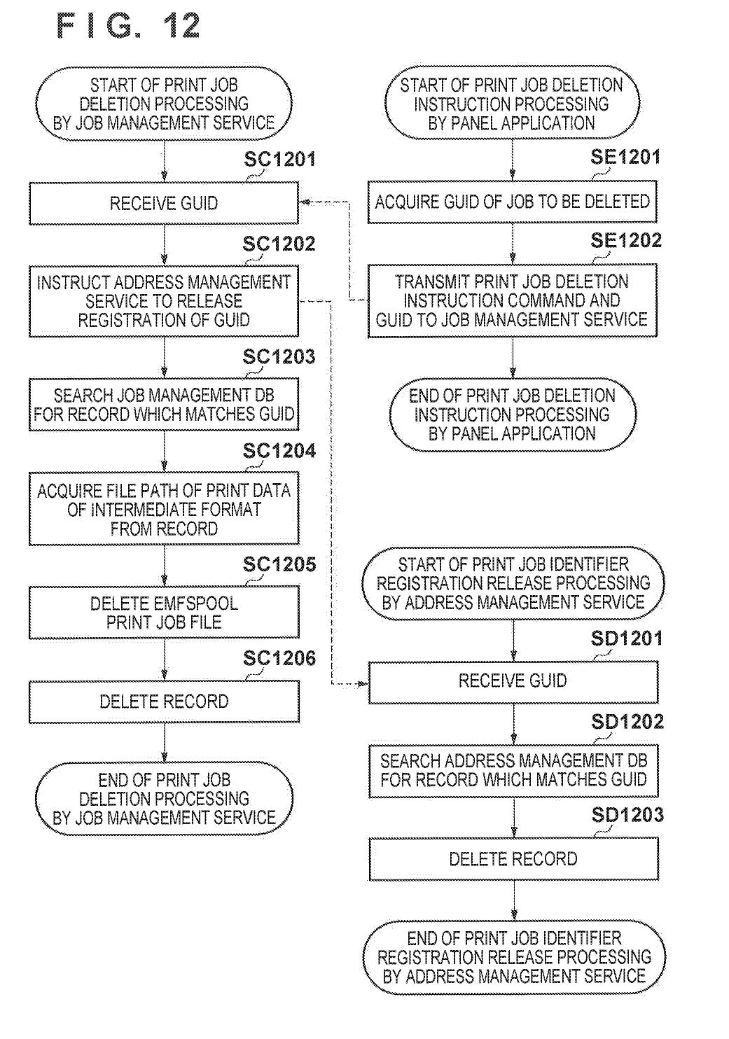

If the panel application 407 determines in step SE1103 that execution, of printing has succeeded (NO in step SE1103), the process advances to step SE1105. In step SE1105, the panel application 407 determines whether a printed document erase check box 1435 shown in FIG. 17A has been checked. The user designates the printed document erase check box 1435. If deletion after printing is designated (YES in step SE1105), the process advances to step SE1106, and the panel application 407 deletes the print job. Details of this processing will be described later with reference to FIG. 12. After that, the process ends.

Next, print processing by the job management service 403 will be explained. After the start of processing by the job management service 403, the job management service 403 receives, in step SC1101, the print instruction command transmitted from the panel application 407 in step SE1101. At this time, the job management service 403 also receives the GUID of a target print job and the model name of the multi-function peripheral 102. In step SC1102, the job management service 403 generates a logical printer for changing a print setting. The contents of this processing are the same a those in step SC902 shown in FIG. 9A. Details of this processing have been described with reference to FIG. 10.

In step SC1103, the job management service 403 searches the job management DB 404 shown in FIG. 4 for a record which matches the GUID acquired in step SC1101. In step SC1104, the job management service 403 acquires an EMFSPOOL file name, DEVMODE, and user token from the detected record. In step SC1105, the job management service 403 disguises its thread using the user token acquired in step SC1104. While the thread is disguised, it is executed in the security context of a user who printed using the client application 400 in FIG. 4.

In step SC1106, the job management service 403 controls the logical printer acquired in step SC1102 to render the EMFSPOOL and DEVMODE acquired in step SC1104 and execute print processing. At this time, the printer driver which forms the logical printer generates PDL and transmits the generated PDL to the multi-function peripheral 102. In step SC1107, the job management, service 403 releases the disguise of the thread. In step SC1108, the job management service 403 sends back a print execution result (success/failure) to the panel application 407. The process then ends.

[Fifth Control Processing Sequence]

FIG. 12 is a flowchart exemplifying the fifth control processing sequence in the printing system according to the embodiment. This sequence corresponds to the processing sequence from 5-1 to 5-4 shown in FIG. 4.

Processes denoted by SE correspond to print job deletion instruction processing by the panel application 407 shown in FIG. 4. These flowchart processes are implemented by loading a program stored in the external memory into the RAM and executing it by the CPU of the multi-function peripheral 102 shown in FIG. 1.

Processes denoted by SC correspond to print job deletion processing by the job management service 403 shown in FIG. 4. These flowchart processes are implemented by loading a program stored in the external memory into the RAM and executing it by the CPU of the print server 101 shown in FIG. 1.

Processes denoted by SD correspond to print job identifier registration release processing by the address management service 405 shown in FIG. 4. These flowchart processes are implemented by loading a program stored in the external memory into the RAM and executing it by the CPU of the address management server 103 shown in FIG. 1.

First, print job deletion instruction processing by the panel application 407 will be explained. As described above, this processing is called in step SE1106 of FIG. 11. This processing can also be called when pressing of an erase button 1421 shown in FIG. 16C is accepted from the user. After the start of processing by the panel application 407, the panel application 407 acquires the GUID of a print job to be deleted in step SE1201. In step SE1202, the panel application 407 transmits a print job deletion instruction command to the job management service 403. At this time, the panel application 407 also transmits the GUID acquired in step SE1201. Thereafter, the process ends.

Next, print job deletion processing by the job management service 403 will be explained. After the start of processing by the job management service 403, the job management service 403 receives, in step SC1201, the print job deletion instruction command transmitted from the panel application 407 in step SE1202. At this time, the job management service 403 also receives the GUID of the print job to be deleted. In step SC1202, the job management service 403 transmits a print job identifier registration release command to the address management service 405. At this time, the job management service 403 also transmits the GUID acquired in step SC1201.

In step SC1203, the job management service 403 searches the job management DB 404 shown in FIG. 4 for a record which matches the GUID received in step SC1201. In step SC1204, the job management service 403 acquires an EMFSPOOL file name from the detected record. In step SC1205, the job management service 403 deletes an EMFSPOOL file corresponding to the acquired file name. In step SC1206, the job management service 403 deletes, from the job management DB 404 shown in FIG. 4, the record found in step SC1203. Then, the process ends.

Print job identifier registration release processing by the address management service 405 will be explained. After the start of processing by the address management service 405, the address management service 405 receives, in step SD1201, the print job identifier registration release command transmitted from the job management service 403 in step SC1202. At this time, the address management service 405 also receives the GUID serving as a target print job identifier. In step SD1202, the address management service 405 searches the address management DB 406 in FIG. 4 for a record which matches the GUID received in step SD1201. In step SD1203, the address management service 405 deletes the record found in step SD1202 from the job management DB 404 in FIG. 4. The process then ends.

[Problem in System]

The following problem occurs in the above-described printing system according to the embodiment. As a condition, the problem occurs when a sheet indicated by a print setting transferred upon receiving a print instruction from the client application 400 in the client PC 100 is a “user registration sheet”. The “user registration sheet” is a sheet for which the user can uniquely set a sheet width, height, margin, and the like and save them in the storage area of the client PC 100, in addition to sheets prepared by each vendor. In the Windows OS, the user registration sheet is prepared as a standard in a form DB 409. The registered user registration sheet can be referred to even from the client application and printer driver in the client PC 100, and can be used together with its sheet settings in printing. However, the form DB 409 can be referred to only from the client PC, and cannot be referred to from the outside without a special mechanism. The special mechanism is, for example, Point and Print connection in the Windows OS in which a printer shared on the server side is installed in a network on the client PC side.

In this environment, the printer driver of the client PC can refer to sheet information in the form DB on the server. In an environment where no special mechanism is arranged, sheet information in the form DB cannot be referred to from the outside. If the user prints under the aforementioned condition, data may be output at a sheet size different from one intended by the user.

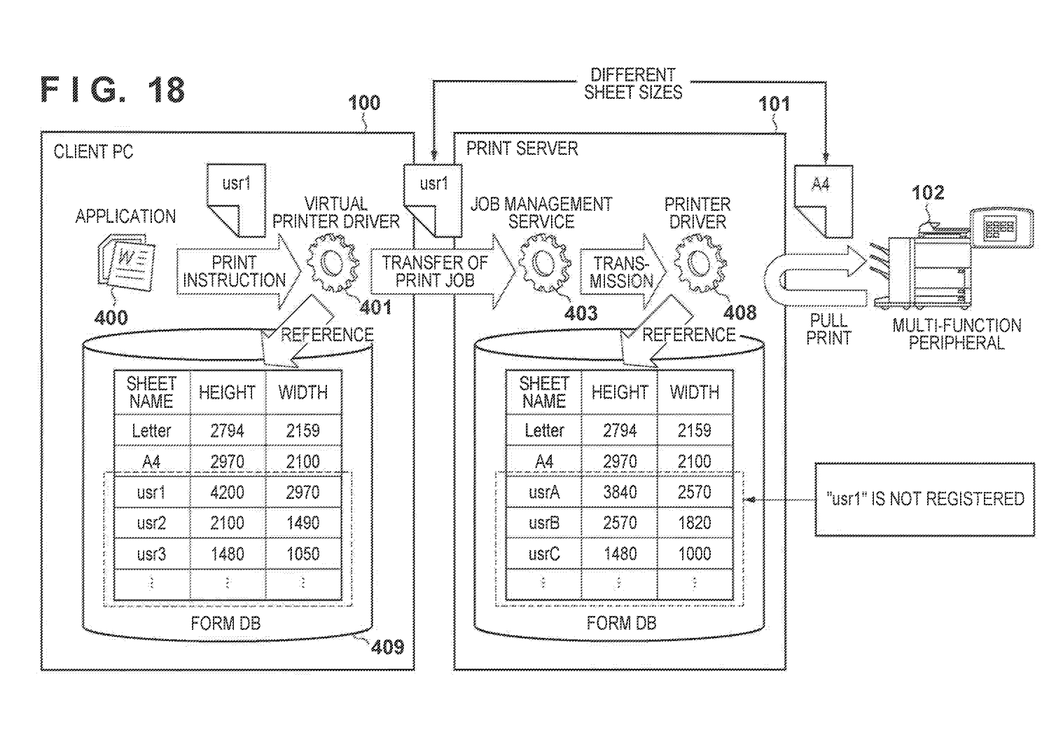

An example will be explained with reference to FIG. 18. Details of the pull print system have already been described, and a description thereof will not be repeated. Assume that the client application 400 of the client PC 100 sets, in print setting information, a sheet “usr1” (height: 4200, width: 2970 (unit: 0.1 mm)) registered in the form DB 409, and issues a print instruction. The virtual printer driver 401 transfers a print job including the designated usr1 to the job management service 403 of the print server 101 via the print processor (not shown). The job management service 403 saves the transferred print job in a specific storage location (job management DB 404). When the printer driver 408 receives a pull print instruction from the multi-function peripheral 102, it acquires the print job via the job management service 408, converts it into PDL, and transfers the PDL to the designated multi-function peripheral 102. At this time, the sheet “usr1” set in the print settings is not registered in the form DB on the server side, so the printer driver 408 of the print server 101 converts it into an improper sheet. Most printer drivers convert the sheet “usr1” into a default sheet (A4), and printing is performed on a sheet different from “usr1” designated by the user.

[Processing to Solve Problem]

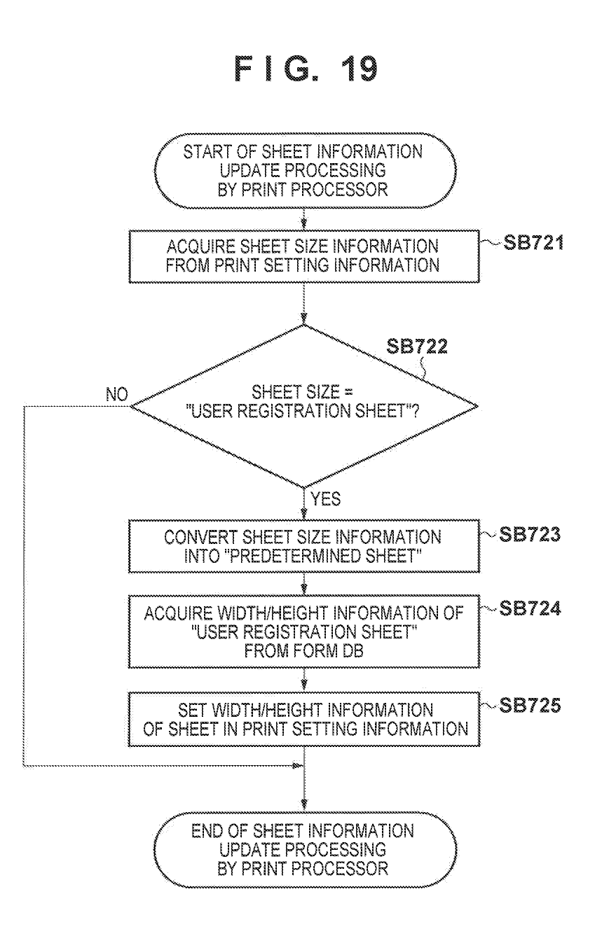

Processing to solve the above problem will be explained with reference to the flowchart of FIG. 19. The following description assumes that the print processor 402 of the client PC 100 executes this processing. In the embodiment, the following flowchart processing is implemented by loading a program stored in the external memory into the RAM and executing it by the CPU of the client PC 100 shown in FIG. 1.

First, the print processor 402 receives a print job from, the virtual printer driver 401, and acquires sheet, size information from print setting information contained in the print job (step SB721). This implements the first acquisition unit. The print processor 402 determines whether the acquired sheet size is the “user registration sheet” (step SB722). If the acquired sheet size is the user registration sheet (YES in step SB722), the print processor 402 converts the sheet size information defined in the print setting information into a “predetermined sheet” (step SB723). The “user registration sheet” is sheet information which is newly defined, by the user in the form DB 409. To the contrary, the “predetermined sheet” is a sheet which is defined as a standard in an OS such as Windows. Note that this processing is implemented by referring to the form DB 409 in step 1-3 shown in FIG. 4,

Generally when printing on Windows, a client application sets only a predetermined unique ID (sheet ID) for the sheet size of print setting information. The printer driver determines a sheet used in printing by referring to the sheet ID. However, when the sheet ID indicates the “predetermined sheet”, the sheet width and height for use in print processing need to be set separately in addition to the sheet ID. In other words, by setting the sheet ID to the “predetermined sheet”, a general printer driver determines a sheet to print by referring to information of the width and height set in print setting information.

By using this function, the print processor 402 acquires, from the form DB 409, information of the width and height defined for the user registration sheet designated by the client application 400 (step SB724). The print processor 402 sets the acquired information in the print setting information of the print job (step SB725). In pull print, data can be output on a sheet at a designated width and height regardless of a sheet registered by the user in the client PC 100 or a print instruction including the setting of this sheet.

The embodiment has assumed that the print processor 402 of the client PC 100 executes this processing, but the virtual printer driver 401 may perform it. In this case, determination is made based, on sheet size information contained in print setting information transferred together with a print instruction (1-1) from the client application 400. Alternatively, the job management service 403 of the print server 101 may perform this processing. In this case, for example, the virtual printer driver 401 or print processor 402 in the client PC 100 notifies the width and height of a designated user registration sheet by adding them to a print job. In this case, the print server 101 may include the form DB.

In the embodiment, when a user registration sheet is designated, information of the width and height is acquired and a print instruction is issued. However, the acquired information is not limited to this, and another sheet item set by the user in printing may be acquired.

### Second Embodiment

In the first embodiment, sheet size information in print setting information is changed from the “user registration sheet” to the “predetermined sheet”. Thus, in pull print from the multi-function peripheral 102, the print setting may change to a sheet size not intended by the user, causing a mismatch.

For example, assume that the multi-function peripheral 102 can perform double-sided printing with the user registration sheet settings and cannot perform it with the predetermined sheet settings. First, the client application 400 of the client PC 100 sets the sheet size “user registration sheet” and “double-sided printing”, and issues a print instruction. Upon receiving a print job accompanying the print, instruction, the print processor 402 changes the “user registration sheet” to the “predetermined sheet” by referring to information of the sheet size (ID). Upon receiving a pull print instruction from the multi-function peripheral 102, the printer driver 408 receives the print job. Since the “predetermined sheet” is defined in the referred print setting information, the printer driver 408 determines that double-sided printing is impossible, and changes the print setting information from “double-sided printing” to “one-sided printing”. Note that processing of changing another print setting (double-sided printing) owing to a given print setting (sheet size) is sometimes called prohibition processing. As a result of changing the setting to the “predetermined sheet”, data is output not by double-sided printing intended, by the user, but by one-sided printing in pull print because of the prohibition processing.

[Processing Sequence]

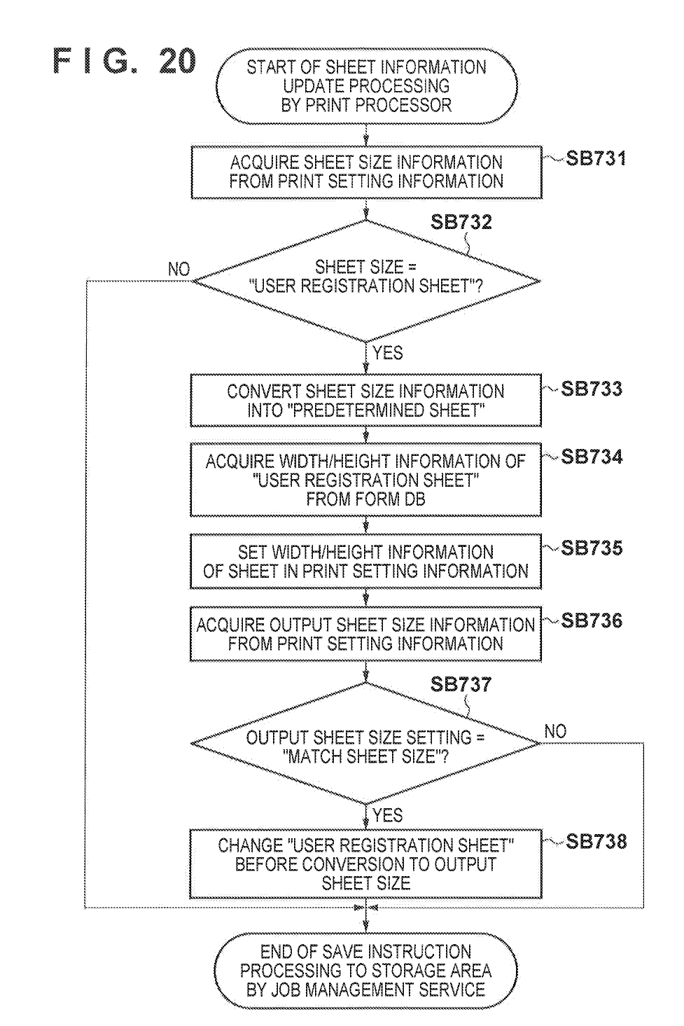

Processing for solving this problem will be explained with reference to the flowchart of FIG. 20. The following flowchart processing is implemented by loading a program stored in the external memory into the RAM and executing it by the CPU of a client PC 100 shown in FIG. 1. Note that steps SB731 to SB735 are the same as steps SB720 to SB725 described with reference to FIG. 19 in the first embodiment, and a description thereof will be omitted.

A print processor 402 acquires output sheet size information from print setting information contained in a print job received from a virtual printer driver 401 (step SB736). The output sheet size will be described later. This implements the second, acquisition unit. In step SB737, the print processor 402 determines whether sheet sizes set in sheet size information and output sheet size information are equal (match). In this case, it is determined whether the set value of the output sheet size is set to “match the sheet size”. If the set value of the output sheet size is set to “match, the sheet size” (YES in step SB737), the print processor 402 sets the “user registration sheet” changed in step SB733 as the output sheet size (step SB738).

The set “output sheet size” is defined on the premise that a sheet size to be actually output is set. This is not an OS standard definition but an item which can be defined uniquely by the vendor, and each vendor uniquely defines the format. For example, in Windows, the “standard part” and “extended part” are defined in the DEVMODE structure of print settings, and the respective parts are used in accordance with application purposes. In the DEVMODE structure, “sheet size” information is defined in the standard part, and “output sheet size” information is defined in the extended part. The set value of the output sheet size is information which can be referred to only by a printer driver capable of interpreting the format of the extended part of the DEVMODE structure in the virtual printer driver 401.

From this, information set in the “standard part” can be used independently of the printer driver (multi-function peripheral). In contrast, whether information set in the “extended part.” can be used changes depending on the printer driver. Mote that the set value “match the sheet size” is a value settable in the “output sheet size” item of the extended part in the DEVMODE structure. A normal printer driver uses sheet information (output sheet information)set in the output sheet size preferentially to sheet information set in the sheet size. The embodiment assumes that a printer driver capable of interpreting the extended part of the DEVMODE structure has been installed, in a print server 101.

If the same sheet information as the user registration, sheet registered in the client PC 100 has been registered even in the print server 101, a printer driver 408 uses the user registration sheet information to determine whether to prohibit another print setting. The user registration sheet information is sheet information set in the “output sheet size”. Data can therefore be output by double-sided printing set by the user in pull print.

### Third Embodiment

In the first embodiment, when the “user registration sheet” is set in the sheet size of print setting information, it is converted into the “predetermined sheet”. In the third embodiment, even when the “user registration sheet” is set in the output sheet size (extended part) of print setting information described in the second embodiment, the set value is converted into the “predetermined sheet”, similar to the sheet size setting. This can prevent even a mismatch which may occur between the set value of the sheet size and that of the output sheet size.

In the embodiment, designated user registration sheet information may be set in the standard part or the extended part.

### Fourth Embodiment

To notify a print server 101 of more detailed sheet information, when the sheet size set in print setting information is the “user registration sheet”, a print processor 402 acquires even margin information from a form DB 409 and reflects it in print settings.

Hence, more detailed information of a sheet can be set and used in printing. Note that the embodiment capable of setting sheet information using information of the width, height, and margin in printing, similar to the first embodiment, has been described. However, another information may be acquired. For example, more detailed information may be acquired for the margin positions (top, bottom, right, and left).

### Fifth Embodiment

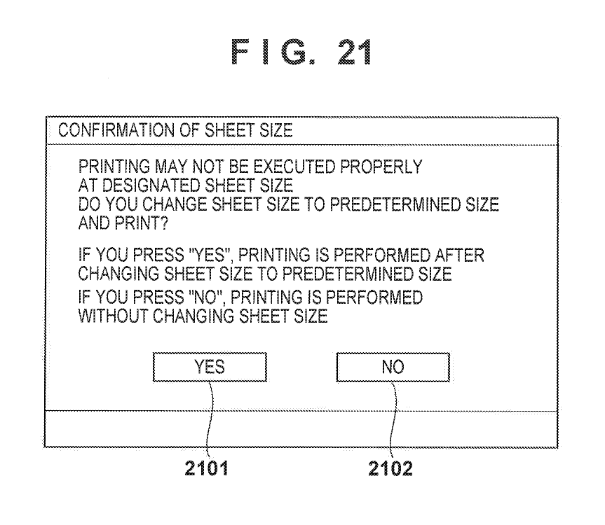

When the sheet size set in print setting information is the “user registration sheet” upon receiving a print instruction from a client application 400, confirmation of whether to change the “user-registration sheet” to the predetermined size described in the first embodiment is presented to the user. FIG. 21 exemplifies a UI to be presented. When the user presses a “YES” button 2101 on the confirmation screen shown in FIG. 21, a print processor 402 executes processing described in the first embodiment. When the user presses a “NO” button 2102, the print processor 402 transmits a print, job without changing the sheet size of print setting information to the “predetermined sheet” even if the sheet size setting is the “user registration sheet”. For example, when it is known that the same sheet as the set user registration sheet has been registered in advance in the print server, this processing is applied, omitting unnecessary conversion processing.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-049608, filed Mar. 7, 2011, which is hereby incorporated by reference herein in its entirety.

What is claimed is:

1. An information processing apparatus which is connected to a print server and includes a printer driver for generating a print job of an intermediate data format independent of a printing apparatus of a specific model, comprising:
a registration unit configured to register, in a storage unit, sheet information set in advance by a user as a user registration sheet;
a first acquisition unit configured to acquire sheet information from print setting information of the print job;
a setting unit configured, when the user registration sheet is designated in the sheet information acquired by said first acquisition unit, to acquire information of the user registration sheet from the storage unit, and to set the information of the user registration sheet in the print setting information of the print job; and
a transmission unit configured to transmit, to the print server, the print job including the print setting information in which said setting unit sets the information of the user registration sheet.

2. The apparatus according to claim 1, wherein the print setting information includes a standard part formed from a setting item independent of a vendor of a printing apparatus, and an extended part formed from a setting item dependent on the vendor of the printing apparatus.

3. The apparatus according to claim 2, further comprising a second acquisition unit configured, when the user registration sheet is designated in sheet information of the standard part, to acquire output sheet information of the extended part from the print setting information of the print job,
wherein when information designated in the sheet information of the standard part coincides with information designated in the output sheet information of the extended part, said setting unit sets, in the output sheet information of the extended part, the user registration sheet designated in the sheet information of the standard part.

4. The apparatus according to claim 2, wherein when the user registration sheet is designated in sheet information of the standard part that is acquired by said first acquisition unit, said setting unit acquires information of the user registration sheet from the storage unit, sets the information of the user registration sheet in sheet information of the standard part, and further sets, in sheet information of the extended part, the user registration sheet designated, in the sheet information of the standard part.

5. The apparatus according to claim 1, wherein the information of the user registration sheet includes information of a sheet width and height.

6. The apparatus according to claim 5, wherein the information of the user registration sheet further includes information of a margin.

7. The apparatus according to claim 1, further comprising a presentation unit configured, when the user registration sheet is designated in the sheet information, to present, to the user, whether to change the sheet information and print.

8. The apparatus according to claim 1, wherein the print setting information is defined in a DEVMODE structure.

9. The apparatus according to claim 1, wherein the intermediate data format is an EMFSPOOL format.

10. A printing system comprising a client apparatus including a printer driver for generating a print job of an intermediate data format independent of a printing apparatus of a specific model, a print server, and a printing apparatus,
said client apparatus including:
a registration unit configured to register, in a storage unit, sheet information set in advance by a user as a user registration sheet;
a first acquisition unit configured to acquire sheet information from print setting information of the print job;
a setting unit configured, when the user registration sheet is designated in the sheet information acquired by said first acquisition unit, to acquire information of the user registration sheet from the storage unit, and to set the information of the user registration sheet in the print setting information of the print job; and
a transmission unit configured to transmit, to the print server, the print job including the print setting information in which said setting unit sets the information of the user registration sheet,
said print server including:
a holding unit configured to hold, in a storage unit, the print job received from said client apparatus; and
a conversion unit configured, in response to a received print request, to convert the print job of the intermediate data format held in the storage unit into a data format corresponding to said printing apparatus using the print setting information, and to transmit the print job to said printing apparatus, and
said printing apparatus including:
an instruction unit configured to transmit the print request to said print server; and
a printing unit configured to receive the print job transmitted from said print server, and to print in response to the print request from said instruction unit.

11. The system according to claim 10, wherein said conversion unit converts a print job of the intermediate data format received from said client apparatus into a PDL format corresponding to said printing apparatus.

12. A method of controlling an information processing apparatus which is connected to a print server and includes a printer driver for generating a print job of an intermediate data format independent of a printing apparatus of a specific model, comprising:
a registration step of registering, in a storage unit, sheet information set in advance by a user as a user registration sheet;
an acquisition step of acquiring sheet information from print setting information of the print job;
a setting step of, when the user registration sheet is designated in the sheet information acquired in the acquisition step, acquiring information of the user registration sheet from the storage unit, and setting the information of the user registration sheet in the print setting information of the print job; and
a transmission step of transmitting, to the print, server, the print job including the print setting information, in which the information of the user registration sheet is set in the setting step.

13. A control method in a printing system including a client apparatus including a printer driver for generating a print job of an intermediate data format independent of a printing apparatus of a specific model, a print server, and a printing apparatus, comprising:
in the client apparatus,
a registration step of registering, in a storage unit, sheet information set in advance by a user as a user registration sheet;
a first acquisition step of acquiring sheet information from print setting information of the print job;
a setting step of, when the user registration sheet is designated in the sheet information acquired in the first acquisition step, acquiring information of the user registration sheet from the storage unit, and setting the information of the user registration sheet in the print setting information of the print job; and
a transmission step of transmitting, to the print server, the print job including the print setting information in which the information of the user registration sheet is set in the setting step,
in the print server,
a holding step of holding, in a storage unit, the print job received from the client apparatus; and
a conversion step of, in response to a received, print request, converting the print job of the intermediate data format held in the storage unit into a data format corresponding to the printing apparatus using the print setting information, and transmitting the print job to the printing apparatus, and
in the printing apparatus,
an instruction step of transmitting the print request to the print server; and
a printing step of receiving the print job transmitted, from the print server, and performing printing in response to the print request from the instruction step.

14. A non-transitory computer-readable medium storing a program for causing a computer to function as
a registration unit configured to register, in a storage unit, sheet information set in advance by a user as a user registration sheet,
an acquisition unit configured to acquire sheet information from print setting information of the print job,
a setting unit configured, when the user registration sheet is designated in the sheet information acquired by said acquisition unit, to acquire information of the user registration sheet from the storage unit, and to set the information of the user registration sheet in the print setting information of the print job, and
a transmission unit configured to transmit, to the print server, the print job including the print setting information in which said setting unit sets the information of the user registration sheet.
